(19) United States
(12) Patent Application Publication
(10) Pub. No.: US 2017/0004593 A1
(43) Pub. Date: Jan. 5, 2017

(54) INFORMATION PROCESSING DEVICE AND NON-TRANSITORY COMPUTER READABLE MEDIUM

(71) Applicant: FUJI XEROX CO., LTD., Tokyo (JP)

(72) Inventor: Koki TOSHIMITSU, Kanagawa (JP)

(73) Assignee: FUJI XEROX CO., LTD., Tokyo (JP)

(21) Appl. No.: 14/976,032

(22) Filed: Dec. 21, 2015

(30) Foreign Application Priority Data
Jun. 30, 2015 (JP) 2015-131659

(51) Int. Cl. G06Q 50/22; G06Q 10/10

(52) U.S. Cl. CPC G06Q 50/22; G06Q 10/10

(57) ABSTRACT

An information processing device includes a generating unit, a disposing unit, and a printing unit. The generating unit generates information images on the basis of identification information for uniquely identifying plural consent documents and serial numbers of the plural consent documents. The plural consent documents are used for obtaining consent to medical care from a patient. The disposing unit disposes the information images generated by the generating unit in the plural consent documents. The printing unit prints the plural consent documents in which the information images are disposed by the disposing unit.

### CROSS-REFERENCE TO RELATED APPLICATIONS

This application is based on and claims priority under 35 USC 119 from Japanese Patent Application No. 2015-131659 filed Jun. 30, 2015.

### BACKGROUND

### Technical Field

The present invention relates to an information processing device and a non-transitory computer readable medium.

### SUMMARY

According to an aspect of the invention, there is provided an information processing device including a generating unit, a disposing unit, and a printing unit. The generating unit generates information images on the basis of identification information for uniquely identifying plural consent documents and serial numbers of the plural consent documents. The plural consent documents are used for obtaining consent to medical care from a patient. The disposing unit disposes the information images generated by the generating unit in the plural consent documents. The printing unit prints the plural consent documents in which the information images are disposed by the disposing unit.

### BRIEF DESCRIPTION OF THE DRAWINGS

An exemplary embodiment of the present invention will be described in detail based on the following figures, wherein:

FIG. 1 is a block diagram illustrating conceptual modules forming an example of the configuration of an exemplary embodiment;

FIG. 2 is a block diagram illustrating conceptual modules forming an example of the configuration of a print processing module;

FIG. 3 is a block diagram illustrating conceptual modules forming an example of the configuration of a scan analysis processing module;

FIGS. 4A and 4B illustrate examples of system configurations to which an exemplary embodiment is applied;

FIGS. 5A and 5B illustrate examples of a consent document (for hospital) and a consent document (for patient), respectively;

FIGS. 6 and 7 illustrate an example of processing for registering consent documents (without information image);

FIGS. 8 through 11 illustrate an example of processing for registering consent documents (with information image);

FIG. 12 illustrates a display example of a document management screen according to an exemplary embodiment;

FIG. 13 illustrates an example of the data structure of a user information management table;

FIG. 14 illustrates an example of the data structure of a patient information management table;

FIG. 15 illustrates an example of the data structure of a document type information management table;

FIG. 16 illustrates an example of the data structure of a consent document page configuration information management table;

FIG. 17 illustrates an example of the data structure of a printed consent document information management table;

FIGS. 18 and 19 are flowcharts illustrating examples of processing executed in an exemplary embodiment;

FIGS. 20 through 31 illustrate examples of processing according to an exemplary embodiment; and

FIG. 32 is a block diagram illustrating an example of the hardware configuration of a computer implementing an exemplary embodiment.

### DETAILED DESCRIPTION

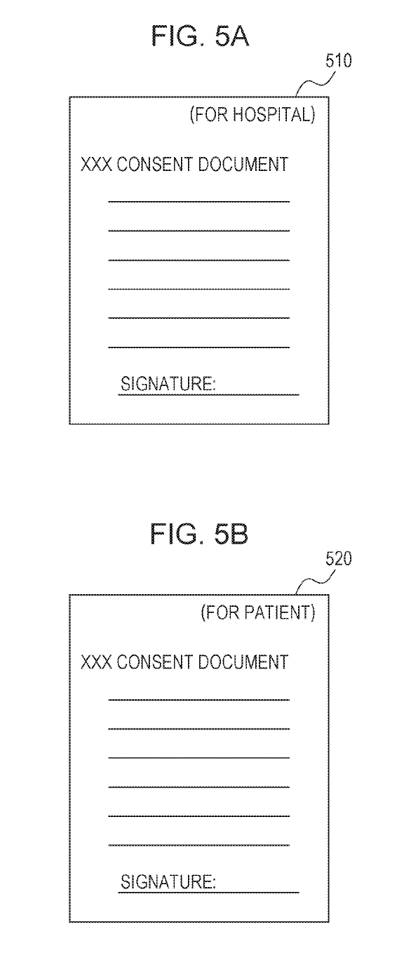

Before discussing an exemplary embodiment of the invention, the basis of this exemplary embodiment and an information processing device to which this exemplary embodiment is applicable will be described first with reference to FIGS. 5A through 11. This description will be given for the purpose of easy understanding of this exemplary embodiment.

In medical settings, medical operations, examinations, and treatments with invasive medical procedures involve risk, and it is necessary to give information concerning such medical care to a patient and receive consent from the patient (informed consent).

In this case, it is necessary to obtain consent in writing, and original document management processing, which will be discussed later, is performed for the original consent document at a medical institution (may be called a hospital), and a copy of the original consent document is given to a patient.

The content of information about a medical treatment or operation may be managed as a medical information document, together with a consent document. Generally, original document management processing is performed for the original documents of a medical information document and a consent document together at a medical institution, and copies of the original documents are given to a patient.

FIGS. 5A and 5B illustrate examples of a consent document (for hospital) 510 and a consent document (for patient) 520, respectively. The consent document (for hospital) 510 is a document for obtaining consent to medical care from a patient. The consent document (for hospital) 510 and the consent document (for patient) 520 are printed, and a patient signs (adds a handwritten signature to) both of the consent document (for hospital) 510 and the consent document (for patient) 520. Then, original document management processing is performed for the consent document (for hospital) 510 at the hospital, while the consent document (for patient) 520 is given to the patient. In this case, the original document management processing is digital management. More specifically, the consent document (for hospital) 510 with a patient's signature is read by using a scanner, and a resulting document image is managed according to the rules concerning the securities and storage period.

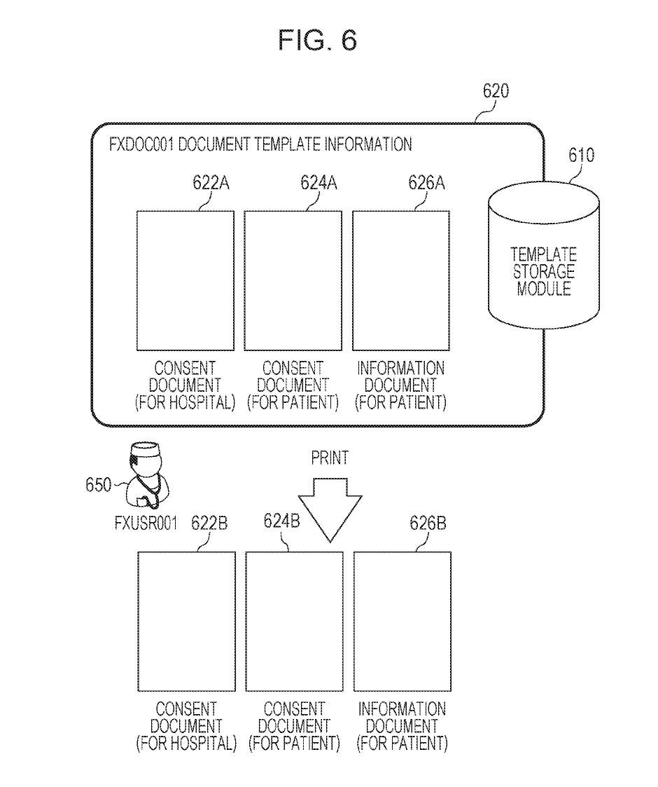

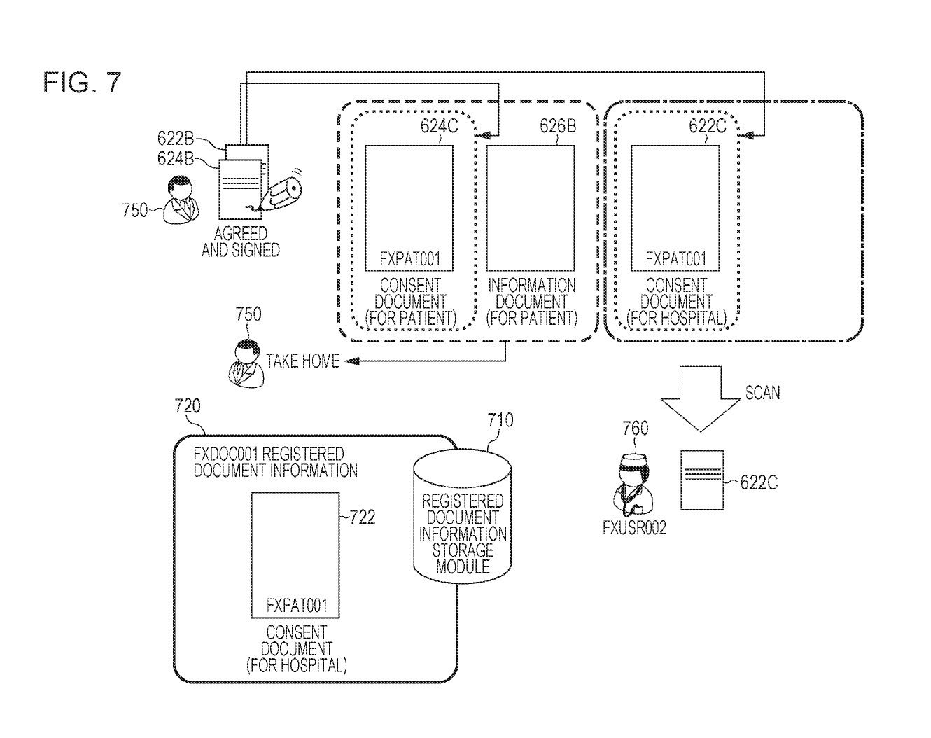

The flow of the management of a consent document and a medical information document (hereinafter may be simply referred to as an “information document”) in an electronic medical record system will now be described below. FIGS. 6 and 7 illustrate an example of processing for registering consent documents (without information image).

1. As shown in FIG. 6, a consent document (for hospital) 622A, a consent document (for patient) 624A, and an information document (for patient) 626A, which are digitally managed as FXDOC001 document template information 620 within a template storage module 610 at the hospital, are printed as a result of a user (FXUSR001) 650, for example, a doctor, operating a printer. As a result, a consent document (for hospital) 622B, a consent document (for patient) 624B, and an information document (for patient) 626B, which are printed paper mediums, are generated.
2. As shown in FIG. 7, a patient 750 adds a handwritten signature to the consent document (for hospital) 622B and the consent document (for patient) 624B.
3. The patient 750 takes home a singed consent document (for patient) 624C and the information document (for patient) 626B and keeps them at home.
4. The hospital scans a signed consent document (for hospital) 622C and performs original document management processing for the scanned image. More specifically, the consent document (for hospital) 622C is scanned as a result of a user (FXUSR002) 760, for example, a nurse, operating a scanner. Then, a consent document (for hospital) 722 (document image of the consent document (for hospital) 622C) is registered in FXDOC001 registered document information 720 of a registered document information storage module 710. In this case, an information document (for hospital) may also be printed, and the printed information document, which is a paper medium, may be scanned together with the consent document (for hospital) 622C.

Consent documents are documents for certifying informed consent conducted between a doctor and a patient. Accordingly, strict management is required for consent documents to ascertain that there is the exact number of registered (collected) document sheets and none of the consent documents are missing, compared with other types of medical records.

The consent document is more influential than other types of documents (such as the above-described information document), and it is necessary to know when (date) and who (user) is printing whose (patient) document and what type of document (printed document information).

Accordingly, it is desirable to manage consent documents together with tracking information.

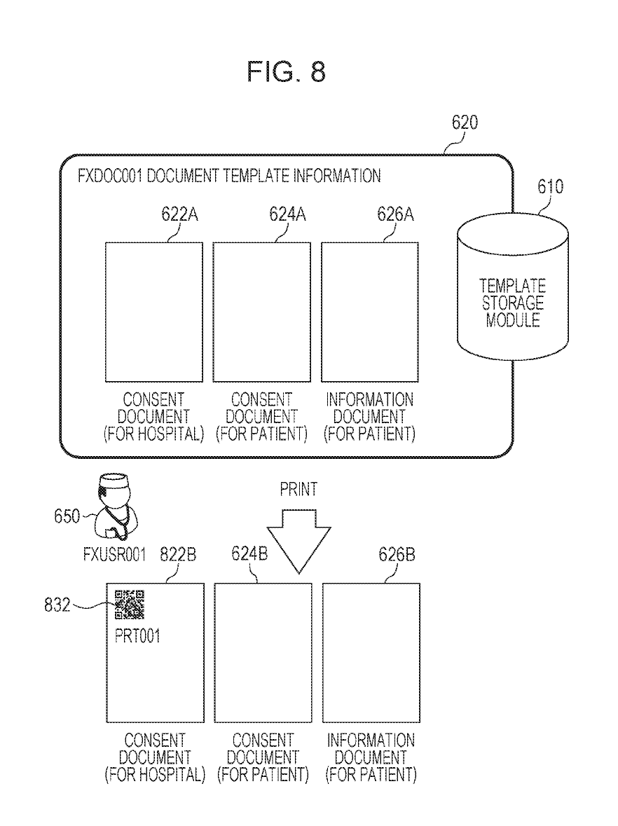

Management of consent documents together with tracking information is implemented, for example, by the following operation, as shown in FIGS. 8 through 11.

1. As shown in FIG. 8, the consent document (for hospital) 622A, the consent document (for patient) 624A, and the information document (for patient) 626A, which are digitally managed as the FXDOC001 document template information 620 within the template storage module 610 at the hospital, are printed as a result of the user (FXUSR001) 650, for example, a doctor, operating a printer. As a result, a consent document (for hospital) 822B, the consent document (for patient) 624B, and the information document (for patient) 626B, which are printed paper mediums, are generated.

In this case, a two-dimensional barcode 832 (which is a specific example of an information image or embedded information) including a consent document management number is printed on the page of the consent document (for hospital) 822B. The information image is a systematically created image code for representing digital data in a machine readable form. Specific examples of the information image are a linear barcode, a two-dimensional barcode, and a digital watermark. In particular, nowadays, QR code (Quick Response code: registered trademark) is being used as a two-dimensional barcode. In this exemplary embodiment, a two-dimensional barcode is used as the information image.

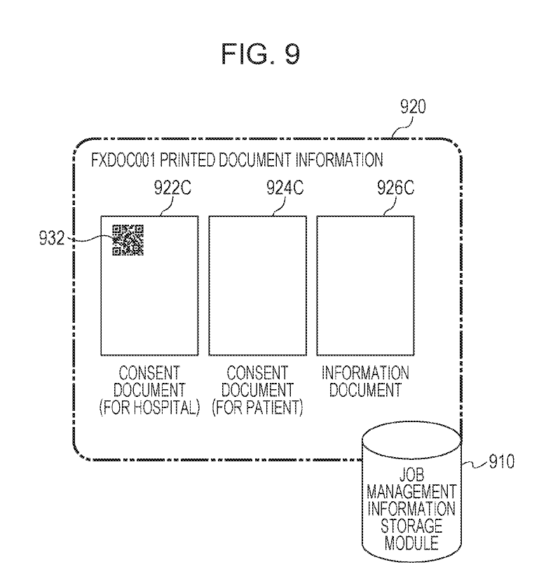

2. As shown in FIG. 9, information concerning the printed documents is registered in a job management information storage module 910, which is a database.

By using the consent document management number as a unique key, patient information, document type code, print processing user information, print processing date, scan processing user information (NULL), scan processing date (NULL), printed document information, and collection status flag (FALSE) are stored.

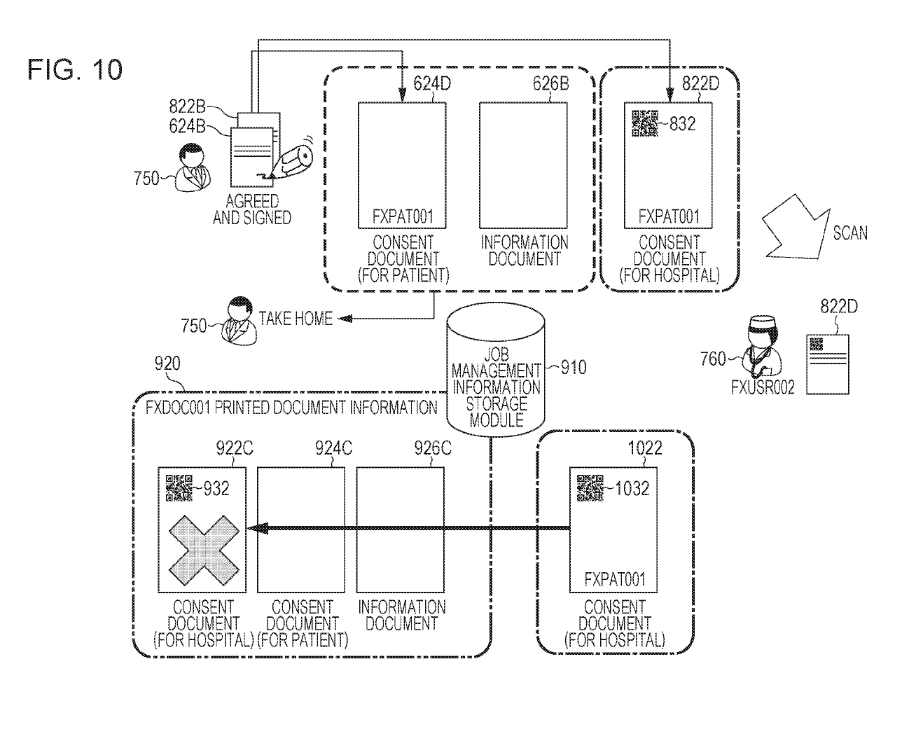

3. As shown in FIG. 10, the patient 750 adds a handwritten signature to the consent document (for hospital) 822B and the consent document (for patient) 624B.
4. The patient 750 takes home a signed consent document (for patient) 624D and the information document (for patient) 626B and keeps them at home.
5. The hospital performs original document management processing by scanning a signed consent document (for hospital) 822D. More specifically, the consent document (for hospital) 822D is scanned as a result of the user (FXUSR002) 760, for example, a nurse, operating a scanner. A consent document (for hospital) 1022 is a document image of the consent document (for hospital) 822D and includes a two-dimensional barcode 1032 obtained by reading the two-dimensional barcode 832.
6. The scanned document (consent document (for hospital) 1022) is analyzed.

The consent document management number is read from the two-dimensional barcode 1032 which is obtained by reading the two-dimensional barcode 832 printed in the consent document (for hospital) 822B.

Then, FXDOC001 printed document information 920 associated with (linked with) the consent document (for hospital) 822D is searched for from the consent document management number.

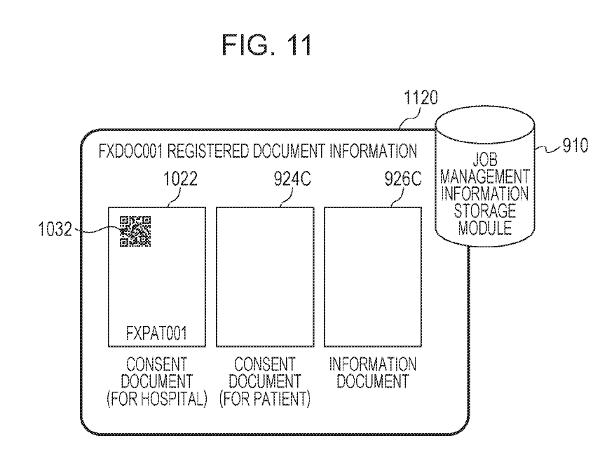

The first page (consent document (for hospital) 922C) in the FXDOC001 printed document information 920 is replaced by the scanned consent document (for hospital) 1022. As a result, as shown in the example of FIG. 11, within FXDOC001 registered document information 1120 in the job management information storage module 910, the consent document (for hospital) 1022, a consent document (for patient) 924C, and an information document 926C are registered.

7. Then, a set of the consent document (for hospital) 1022, the consent document (for patient) 924C, and the information document 926C is subjected to original document management processing.
8. The scan processing user information, scan processing date, and collection status flag of the subject consent document management number are updated.

According to the above-described procedure, it is possible to keep track of whether or not a printed consent document has been registered (collected) and also to manage consent documents together with an associated information document, that is, a set of the consent document (for hospital) 1022, the consent document (for patient) 924C, and the information document 926C.

Original document management processing may be performed for an information document (for hospital) in the following manner. The information document (for hospital) is printed, and the printed information document (for hospital) is scanned together with the consent document (for hospital) 822D. Then, the information document 926C is replaced by the scanned image of the information document (for hospital).

An exemplary embodiment of the invention will be described below with reference to the accompanying drawings.

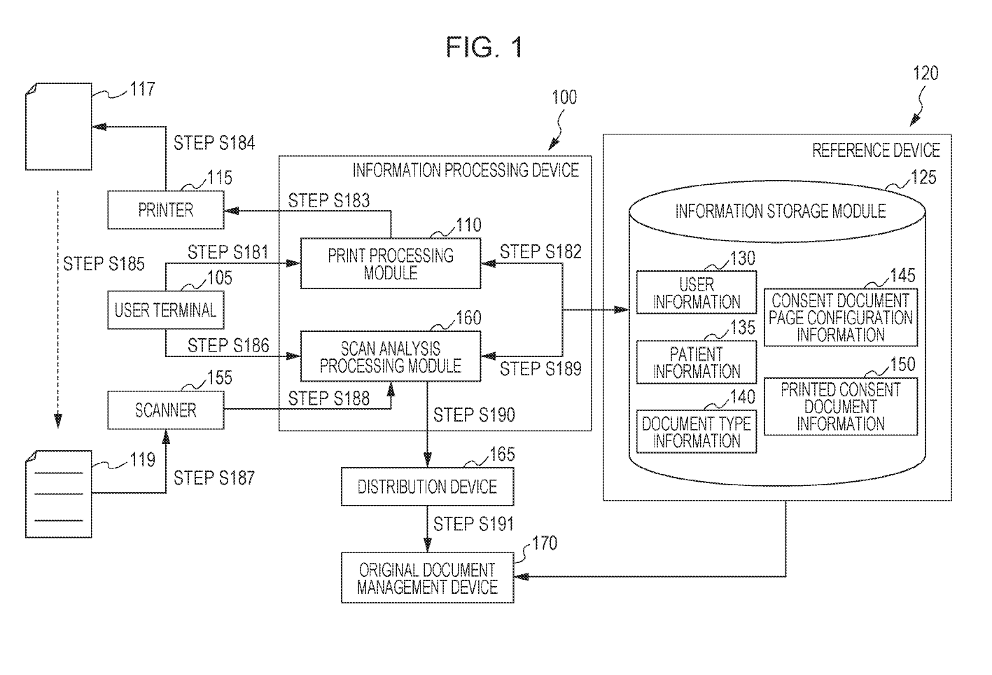

FIG. 1 is a block diagram illustrating conceptual modules forming an example of the configuration of the exemplary embodiment of the invention.

Generally, modules are software (computer programs) components or hardware components that can be logically separated from one another. Accordingly, the modules of the exemplary embodiment of the invention are not only modules of a computer program, but also modules of a hardware configuration. Thus, the exemplary embodiment will also be described in the form of a computer program for allowing a computer to function as those modules (a program for causing a computer to execute program steps, a program for allowing a computer to function as corresponding units, or a computer program for allowing a computer to implement corresponding functions), a system, and a method. While expressions such as “store”, “storing”, “being stored”, and equivalents thereof are used for the sake of description, such expressions indicate, when the exemplary embodiment relates to a computer program, storing the computer program in a storage device or performing control so that the computer program is stored in a storage device. Modules may correspond to functions based on a one-to-one relationship. In terms of implementation, however, one module may be constituted by one program, or plural modules may be constituted by one program. Conversely, one module may be constituted by plural programs. Additionally, plural modules may be executed by using a single computer, or one module may be executed by using plural computers in a distributed or parallel environment. One module may integrate another module therein. Hereinafter, the term “connection” includes not only physical connection, but also logical connection (sending and receiving of data, giving instructions, reference relationships among data elements, etc.). The term “predetermined” means being determined prior to a certain operation, and includes the meaning of being determined prior to a certain operation before starting processing of the exemplary embodiment, and also includes the meaning of being determined prior to a certain operation even after starting processing of the exemplary embodiment, in accordance with the current situation/state or in accordance with the previous situation/state. If there are plural “predetermined values”, they may be different values, or two or more of the values (or all the values) may be the same. A description having the meaning “in the case of A, B is performed” is used as the meaning “it is determined whether the case A is satisfied, and B is performed if it is determined that the case A is satisfied”, unless such a determination is unnecessary.

A system or an apparatus may be realized by connecting plural computers, hardware units, devices, etc., to one another via a communication medium, such as a network (including communication based on a one-to-one correspondence), or may be realized by a single computer, hardware unit, device, etc. The terms “apparatus” and “system” are used synonymously. The term “system” does not include merely a man-made social “mechanism” (social system).

Additionally, every time an operation is performed by using a corresponding module or every time each of plural operations is performed by using a corresponding module, target information is read from a storage device, and after performing the operation, a processed result is written into the storage device. Accordingly, a description of reading from the storage device before an operation or writing into the storage device after an operation may be omitted. Examples of the storage device may be a hard disk (HD), a random access memory (RAM), an external storage medium, a storage device using a communication line, a register within a central processing unit (CPU), etc.

An information processing device 100 of this exemplary embodiment processes plural consent documents for obtaining consent to medical care from patients. As shown in FIG. 1, the information processing device 100 includes a print processing module 110 and a scan analysis processing module 160. The information processing device 100 has a consent-document tracking management function. In this case, the tracking management of consent documents includes at least the recording of information that a consent document has been printed and information that a signed consent document has been read by using a scanner.

A user terminal 105 is connected to the print processing module 110 and the scan analysis processing module 160 of the information processing device 100. The user terminal 105 requests the print processing module 110 to perform print processing and the scan analysis processing module 160 to perform scan processing. The user terminal 105 is operated by a medical practitioner, such as a doctor or a nurse, and instructs the print processing module 110 to print a consent document 117 and a scan analysis processing module 160 to read a consent document (signed) 119. The user terminal 105 may be, for example a personal computer (PC), a tablet terminal, or a mobile terminal.

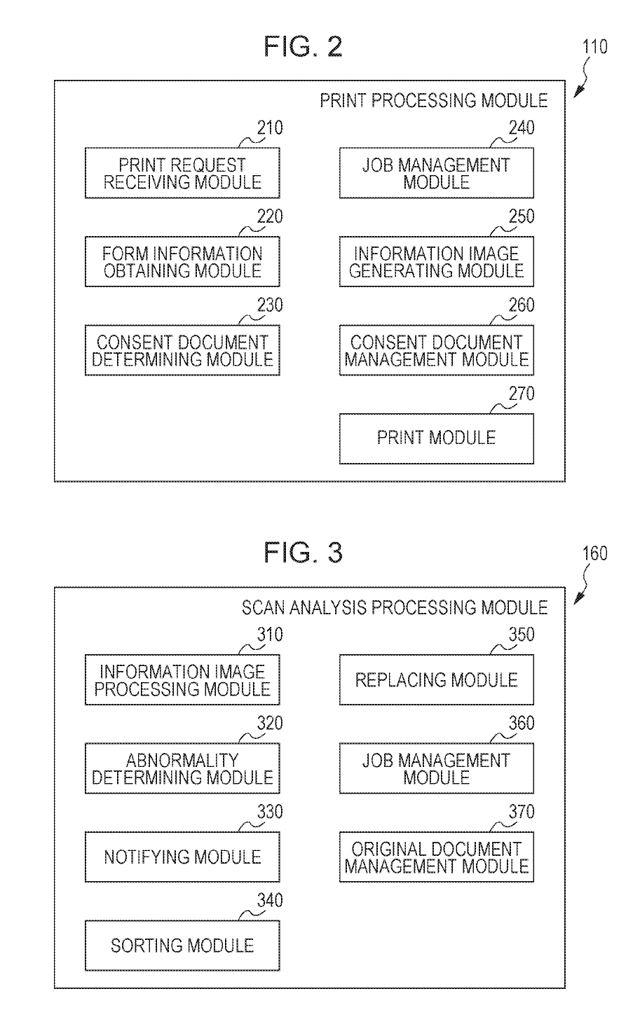

The print processing module 110 is connected to the user terminal 105, a printer 115, and an information storage module 125 of a reference device 120. Upon receiving a print processing request from the user terminal 105, the print processing module 110 requests the printer 115 to print form information. More specifically, the print processing module 110 has a function of creating the consent document 117 appended with an information image, instructing the printer 115 to print the consent document 117, and managing information that the consent document 117 has been printed. The module configuration and the functions of the information processing device 100 will be discussed later with reference to FIG. 2.

The printer 115 is connected to the print processing module 110 of the information processing device 100. The printer 115 prints form information on a paper medium. More specifically, the printer 115 prints consent documents, such as the consent document 117, created by the print processing module 110. Specific examples of the consent document 117 are the consent document (for hospital) 510 and the consent document (for patient) 520 shown in FIGS. 5A and 5B, respectively. In this case, however, the consent document 117 is appended with an information image.

The reference device 120 includes the information storage module 125 and is connected to an original document management device 170. The reference device 120 is accessed from the information processing device 100 and the original document management device 170 and reads and writes data into and from the information storage module 125. For example, the reference device 120 refers to tracking information concerning a printed consent document in accordance with access from the information processing device 100.

The information storage module 125 stores therein user information 130, patient information 135, document type information 140, consent document page configuration information 145, and printed consent document information 150. The information storage module 125 is connected to the print processing module 110 and the scan analysis processing module 160 of the information processing device 100. The information storage module 125 has a function as a database, and stores therein the user information 130, the patient information 135, the document type information 140, the consent document page configuration information 145, and the printed consent document information 150, as stated above. The printed consent document information 150 includes job information and content information concerning a printed consent document.

A scanner 155 is connected to the scan analysis processing module 160 of the information processing device 100. The scanner 155 reads the consent document (signed) 119 and supplies a document image indicating the consent document (signed) 119 to the scan analysis processing module 160. The consent document (signed) 119 is a document obtained by signing the consent document 117 by a patient. Accordingly, the consent document (signed) 119, as well as the consent document 117, is appended with an information image.

The scan analysis processing module 160 is connected to the user terminal 105, the information storage module 125 of the reference device 120, the scanner 155, and a distribution device 165. Upon receiving a scan processing request from the user terminal 105, the scan analysis processing module 160 instructs the scanner 155 to scan the consent document (signed) 119. More specifically, on the basis of the information image appended to the document image of the consent document (signed) 119, the scan analysis processing module 160 checks whether or not the consent document (signed) 119 (signed consent document 117) has been collected.

The distribution device 165 is connected to the scan analysis processing module 160 of the information processing device 100 and the original document management device 170. The distribution device 165 distributes document information subjected to scan analysis processing to the original document management device 170. More specifically, the distribution device 165 supplies the processing results (including the document image of the consent document (signed) 119) obtained by the scan analysis processing module 160 to the original document management device 170.

The original document management device 170 is connected to the reference device 120 and the distribution device 165. The original document management device 170 performs original document management processing for document information supplied from the distribution device 165. More specifically, the original document management device 170 performs original document management processing to check whether or not the consent document 117 has been printed and whether or not the consent document (signed) 119 has been collected. For example, the original document management device 170 stores a print image of the consent document 117 and a document image obtained by reading the consent document (signed) 119.

An example of processing executed by the print processing module 110 and the scan analysis processing module 160 will now be discussed below with reference to FIG. 1.

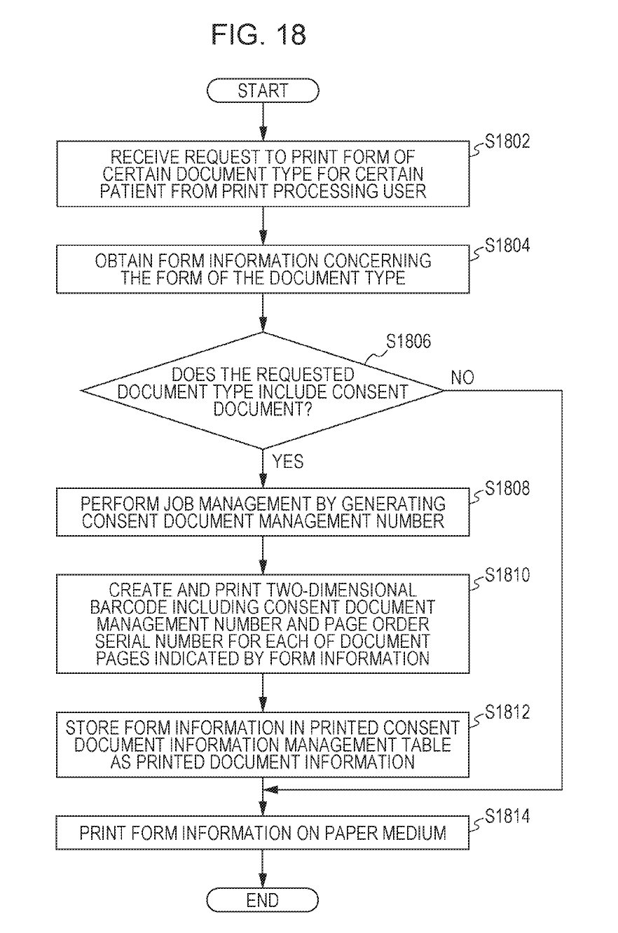

In step S181 of FIG. 18, the user terminal 105 receives an instruction to print, for example, the consent document 117, from a medical practitioner, and requests the print processing module 110 to perform print processing.

In step S182, upon receiving a print processing request for a certain form from the user terminal 105, the print processing module 110 determines whether or not the form to be subjected to print processing is a consent document by using the document type information 140 stored in the information storage module 125.

In step S183, the print processing module 110 creates job information concerning a consent document to be printed, and then creates a two-dimensional barcode from the job information concerning the consent document to be printed and consent document page configuration information. The print processing module 110 then appends the two-dimensional barcode to each page of the consent document to be printed, and instructs the printer 115 to perform printing.

In step S184, the printer 115 prints the consent document 117 in accordance with the print instruction from the print processing module 110.

In step S185, the patient receives an explanation about medical care from a medical practitioner and signs the consent document 117 so as to create the consent document (signed) 119.

In step S186, the user terminal 105 receives an instruction to read the consent document (signed) 119 from a medical practitioner, and requests the scan analysis processing module 160 to perform scan processing.

In step S187, the scanner 155 reads the consent document (signed) 119 in accordance with a request to perform scan processing from the scan analysis processing module 160.

In step S188, the scanner 155 supplies a document image of the consent document (signed) 119 to the scan analysis processing module 160.

In step S189, the scan analysis processing module 160 determines whether or not a two-dimensional barcode is appended to the document images forming all pages of the consent document (signed) 119. Then, the scan analysis processing module 160 specifies the document images of pages appended with a two-dimensional barcode, and extracts job information concerning the printed consent document and the consent document page configuration information from each two-dimensional barcode. If there is a page for which the job information of the two-dimensional barcode does not coincide with that of the two-dimensional barcodes of the other pages, the scan analysis processing module 160 issues an abnormality occurrence notification. Additionally, if there is excess and deficiency concerning the page configuration indicated by the consent document page configuration information of the two-dimensional barcode of each page, the scan analysis processing module 160 also issues an abnormality occurrence notification. Then, the scan analysis processing module 160 sorts the pages representing the document images in accordance with the consent document page configuration information, and then replaces the pages indicated by the content information concerning the printed consent document by the pages representing the document images.

In step S190, the scan analysis processing module 160 sends the content information concerning the printed consent document replaced by the document images to the distribution device 165.

In step S191, the distribution device 165 sends the content information concerning the printed consent document to the original document management device 170. The original document management device 170 stores the document images of the consent document therein.

According to the above-described processing, even if one document type includes plural consent documents (consent document having plural pages), tracking management is performed to check whether or not the plural consent documents have been collected (registered) without excess or deficiency. In this case, one document type refers to the type of a set of documents for giving information concerning medical care to a patient. A set of documents of this document type may include plural consent documents (or plural pages). According to the above-described processing, tracking management that can handle such a situation is performed.

FIG. 2 is a block diagram illustrating conceptual modules forming an example of the configuration of the print processing module 110.

The print processing module 110 includes a print request receiving module 210, a form information obtaining module 220, a consent document determining module 230, a job management module 240, an information image generating module 250, a consent document management module 260, and a print module 270.

The print request receiving module 210 receives a print request from the user terminal 105.

The form information obtaining module 220 obtains form information corresponding to the print request received by the print request receiving module 210.

The consent document determining module 230 determines whether or not a form to be printed includes a consent document by using the form information obtained by the form information obtaining module 220.

The job management module 240 manages a print job. More specifically, the job management module 240 generates identification information for uniquely identifying a consent document (hereinafter such identification information may be referred to as a “consent document management number”).

The information image generating module 250 generates information images on the basis of the identification information for uniquely identifying plural consent documents for obtaining consent to medical care from a patient and the serial numbers of the plural consent documents. Then, the information image generating module 250 appends the generated information images to the plural consent documents. It is possible, as a matter of course, to extract the identification information and the serial numbers of the consent documents from these information images.

In this case, it is assumed that there are plural consent documents for obtaining consent to medical care from a patient and that identification information for uniquely identifying such plural consent documents is generated. Accordingly, the same identification information is appended to the plural consent documents. This identification information is also used for identifying a set of printed documents of one document type.

The information image generating module 250 may generate information images on the basis of the number of sheets of consent documents. It is possible, as a matter of course, to extract the identification information, the serial numbers of the consent documents, and the number of sheets of the consent documents from these information images.

The consent document management module 260 manages the document images of printed consent documents.

The print module 270 causes the printer 115 to print the plural consent documents appended with the information images by the information image generating module 250 and medical information documents.

FIG. 3 is a block diagram illustrating conceptual modules forming an example of the configuration of the scan analysis processing module 160.

The scan analysis processing module 160 includes an information image processing module 310, an abnormality determining module 320, a notifying module 330, a sorting module 340, a replacing module 350, a job management module 360, and an original document management module 370.

The information image processing module 310 reads, as document images, signed plural consent documents for obtaining consent to medical care from a patient. Then, the information image processing module 310 extracts identification information for uniquely identifying the consent documents and the serial numbers of the consent documents from the information images located within the read plural document images. Generally, the person signed the consent documents is a subject patient.

The information image processing module 310 may also extract the number of sheets of consent documents from the information images.

The abnormality determining module 320 determines whether or not the identification information located within the information images within the individual document images is identical.

The notifying module 330 issues an abnormality occurrence notification if the abnormality determining module 320 determines that an abnormality has occurred. That is, if the identification information located within the information images of the individual document images is not identical, or if the number of sheets of consent documents indicated by the information images does not coincide with that of consent documents appended with the identification information, the notifying module 330 issues an abnormality occurrence notification. As the issuance of an abnormality occurrence notification, a message may be displayed on the user terminal 105 which has instructed the scan analysis processing module 160 to read the signed consent documents by using the scanner 155, or sound or vibration may be issued. Alternatively, an email may be sent to the person in charge.

If the identification information within the information images of the individual document images is identical, the sorting module 340 sorts the document images in accordance with the serial numbers.

Alternatively, if the identification information within the information images of the individual document images is identical and if the number of sheets of consent documents indicated by the information images coincides with that of consent documents appended with the identification information, the sorting module 340 may sort the document images in accordance with the serial numbers.

The replacing module 350 replaces information concerning the printed consent documents by the document images obtained by reading the printed consent documents. As a result of performing this replacement processing, the printed consent documents are collected as signed consent documents. The information concerning the printed consent documents may be document images generated when the consent documents are printed, for example, bitmap images or portable document format (PDF) images.

The job management module 360 checks whether or not printed consent documents corresponding to a print job have been collected.

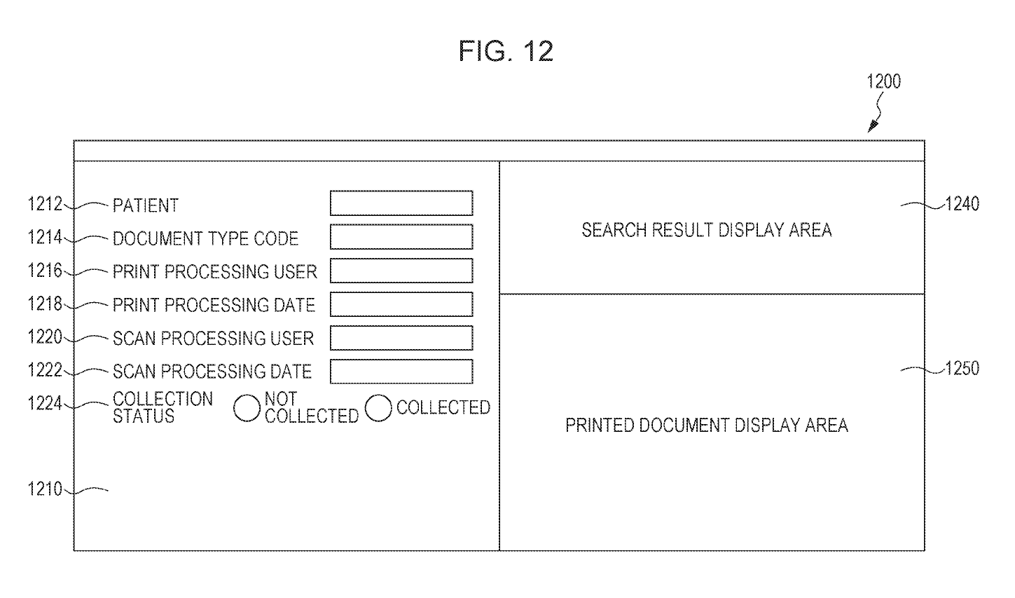

The original document management module 370 performs original document management processing to check whether or not consent documents have been printed and whether or not printed consent documents have been collected. For example, the original document management module 370 displays a document management screen 1200 to show a current situation of consent documents. FIG. 12 illustrates a display example of the document management screen 1200 according to this exemplary embodiment. The document management screen 1200 includes a basic information display area 1210, a search result display area 1240, and a printed document display area 1250. The basic information display area 1210 includes a patient field 1212, a document type code field 1214, a print processing user field 1216, a print processing date field 1218, a scan processing user field 1220, a scan processing date field 1222, and a collection status field 1224. In the patient field 1212, a subject patient (may be a patient ID (identification) for uniquely identifying the subject patient in this exemplary embodiment) is displayed. In the document type code field 1214, a document type of a set of documents supplied (or explained) to the patient is displayed. In the print processing user field 1216, a user name (may be a user ID) who has given an instruction to print the documents of this document type is displayed. In the print processing date field 1218, the date (may be year, month, day, hour, minute, second, millisecond, or a combination thereof) when the documents are printed is displayed. In the scan processing user field 1220, a user name (may be a user ID for uniquely identifying the user in this exemplary embodiment) who has given an instruction to scan the documents of this document type is displayed. In the scan processing date field 1222, the date when the documents are scanned is displayed. In the collection status field 1224, information indicating whether or not the consent documents have been collected is displayed. An item within the basic information display area 1210 may be specified as a key for conducting a search by a user. In the search result display area 1240, search results obtained by conducting a search by using an item within the basic information display area 1210 specified as a key are displayed. In the printed document display area 1250, printed document images or scanned document images are displayed.

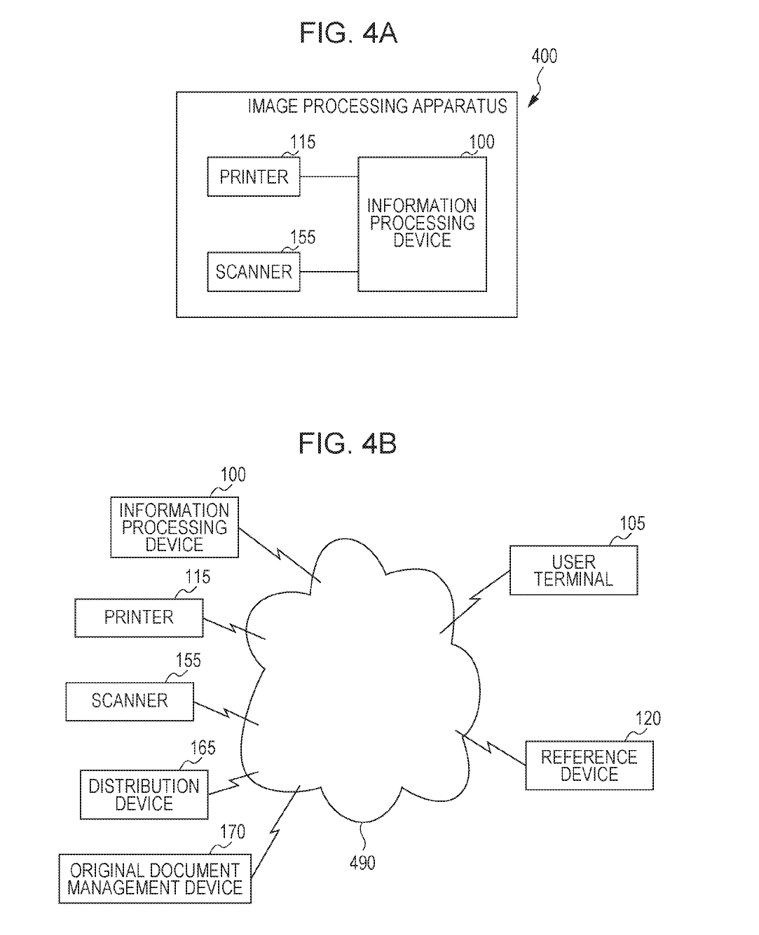

FIGS. 4A and 4B illustrate examples of system configurations to which this exemplary embodiment is applied.

FIG. 4A illustrates an example of this exemplary embodiment configured as a stand-alone system. An image processing apparatus 400 includes the information processing device 100, the printer 115, and the scanner 155. In accordance with an instruction from the image processing apparatus 400, a consent document created in the information processing device 100 is printed by using the printer 115, and a signed consent document is read by using the scanner 155. Then, the information processing device 100 performs original document management processing for determining whether or not the signed consent document has been collected.

FIG. 4B illustrates an example of this exemplary embodiment configured as a system using a communication network 490. The information processing device 100, the user terminal 105, the printer 115, the reference device 120, the scanner 155, the distribution device 165, and the original document management device 170 are connected to one another via the communication network 490. The communication network 490 may be a wireless or wired medium, or a combination thereof, and may be, for example, the Internet or an intranet as a communication infrastructure. The functions of the information processing device 100, the reference device 120, and the original document management device 170 may be implemented as cloud services.

Specific examples of the items of information within the information storage module 125 will be discussed below.

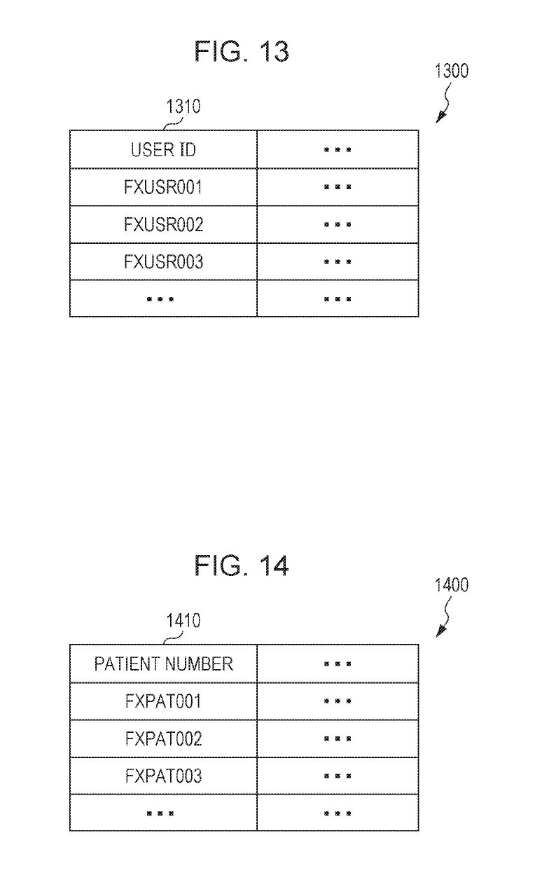

An example of the user information 130 is a user information management table 1300. FIG. 13 illustrates an example of the data structure of the user information management table 1300. The user information management table 1300 has a user ID field 1310. In the user ID field 1310, a user ID is stored. In addition to the user ID, the name, gender, qualification (such as a doctor or a nurse), department of the user may be stored in association with each other.

An example of the patient information 135 is a patient information management table 1400. FIG. 14 illustrates an example of the data structure of the patient information management table 1400. The patient information management table 1400 has a patient number field 1410. In the patient number field 1410, a patient number (patient ID) is stored. In addition to the patient number, the name, gender, address, age, and disease of the patient may be stored in association with each other.

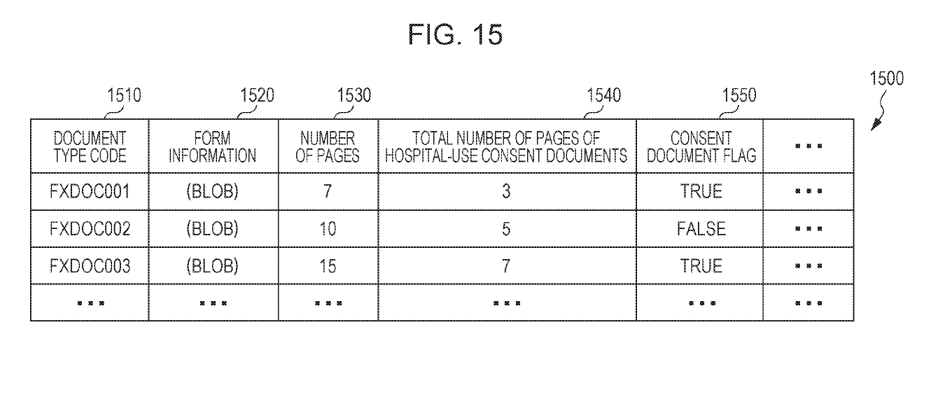

An example of the document type information 140 is a document type information management table 1500. FIG. 15 illustrates an example of the data structure of the document type information management table 1500. The document type information management table 1500 has a document type code field 1510, a form information field 1520, a number-of-page field 1530, a hospital-use consent document total-number-of-page field 1540, and a consent document flag field 1550. In the document type code field 1510, a document type code is stored. In the form information field 1520, form information indicating the template of this document type is stored. In the number-of-page field 1530, the number of pages of this document type is stored. In the hospital-use consent document total-number-of-page field 1540, the total number of pages of the hospital-use consent documents of this document type is stored. In the consent document flag field 1550, a consent document flag indicating whether or not this document type includes a consent document is stored.

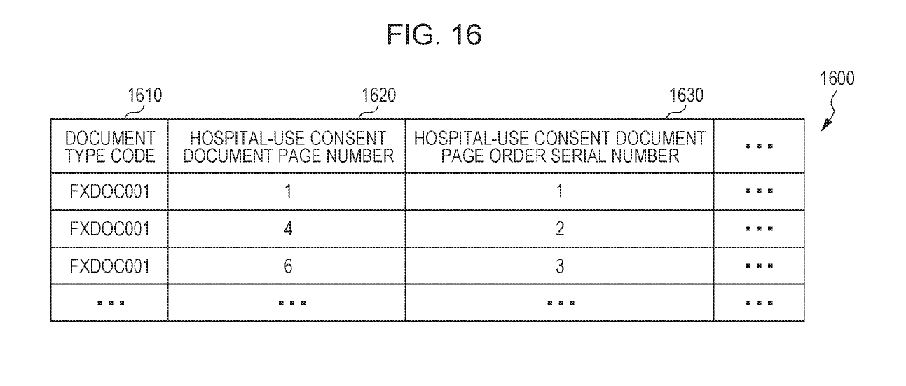

An example of the consent document page configuration information 145 is a consent document page configuration information management table 1600. FIG. 16 illustrates an example of the data structure of the consent document page configuration information management table 1600. The consent document page configuration information management table 1600 has a document type code field 1610, a hospital-use consent document page number field 1620, and a hospital-use consent document page order serial number field 1630. In the document type code field 1610, a document type code is stored. In the hospital-use consent document page number field 1620, the page number of a hospital-use consent document in this document type, that is, the page number of a subject hospital-use consent document among the consent documents to be printed, is stored. In the hospital-use consent document page order serial number field 1630, the page order serial number of the subject hospital-use consent document is stored. That is, this document type includes plural consent documents, and the serial number of a subject consent document among these plural consent documents (the order of only the consent documents in this document type) is stored.

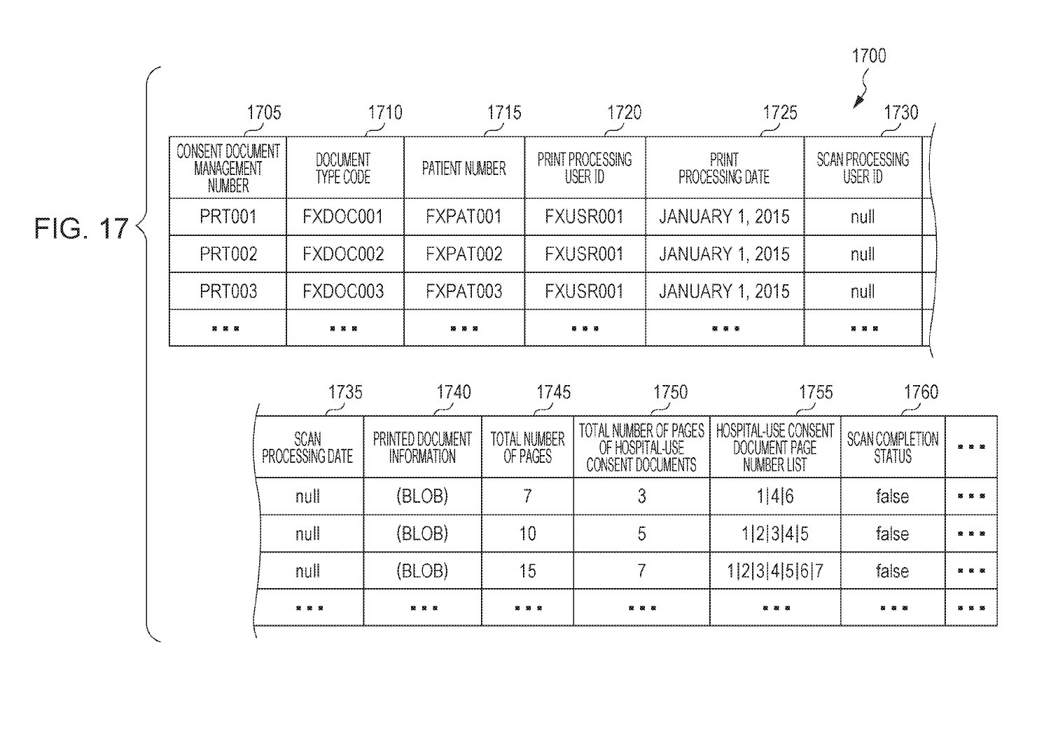

An example of the printed consent document information 150 is a printed consent document information management table 1700. FIG. 17 illustrates an example of the data structure of the printed consent document information management table 1700. The printed consent document information management table 1700 has a consent document management number field 1705, a document type code field 1710, a patient number field 1715, a print processing user ID field 1720, a print processing date field 1725, a scan processing user ID field 1730, a scan processing date field 1735, a printed document information field 1740, a total-number-of-page field 1745, a hospital-use consent document total-number-of-page field 1750, a hospital-use consent document page number list field 1755, and a scan completion status field 1760. In the consent document management number field 1705, a consent document management number, which is identification information for uniquely identifying a consent document, is stored. In the document type code field 1710, the document type code corresponding to this consent document management number, that is, the document type code representing a document type printed with this consent document management number, is stored. In the patient number field 1715, the patient number of a patient to which the documents of the document type printed with this consent document management number are supplied is stored. In the print processing user ID field 1720, the user ID of a user who has given a print instruction corresponding to this consent document management number is stored. In the print processing date field 1725, the date when the print processing is performed is stored. In the scan processing user ID field 1730, the user ID of a user who has given a scan instruction corresponding to this consent document management number is stored. In the scan processing date field 1735, the date when the scan processing is performed is stored. In the printed document information field 1740, document information concerning the documents printed by this print processing is stored. In the total-number-of-page field 1745, the total number of pages of the printed documents is stored. In the hospital-use consent document total-number-of-page field 1750, the total number of pages of hospital-use consent documents among the printed documents is stored. In the hospital-use consent document page number list field 1755, a page number list of the hospital-use consent documents is stored. In this case, the page numbers in the list are the page numbers of the hospital-use consent documents among all the printed documents. In the scan completion status field 1760, information indicating whether or not scanning of the consent documents has been completed is stored.

FIG. 18 is a flowchart illustrating an example of processing executed in this exemplary embodiment.

In step S1802, the print request receiving module 210 of the print processing module 110 receives a request to print a form of a certain document type for a certain patient from a print processing user. More specifically, a doctor (print processing user) prints a form for a patient who will receive medical care by using an electronic medical record terminal (user terminal 105). The print processing module 110 receives a print processing request for a form.

In step S1804, the form information obtaining module 220 obtains form information (template) concerning this document type. More specifically, the form information obtaining module 220 obtains form information concerning the form requested in the print processing request.

In step S1806, the consent document determining module 230 determines whether or not the document type requested in the print processing request includes a consent document. If a consent document is included, the process proceeds to step S1808. If a consent document is not included, the process proceeds to step S1814. The consent document determining module 230 makes this determination according to the value of the consent document flag field 1550 of the document type information management table 1500.

In step S1808, the job management module 240 performs job management by generating a consent document management number from the print processing user information, patient information, document information, and print processing date. More specifically, the job management module 240 generates a consent document management number (sequence number), which is a unique number in the printed consent document information management table 1700. Then, by using the consent document management number as a key, the job management module 240 stores data in the document type code field 1710, the patient number field 1715, the print processing user ID field 1720, the print processing date field 1725, the total-number-of-page field 1745, the hospital-use consent document total-number-of-page field 1750, and the hospital-use consent document page number list field 1755. The job management module 240 also sets FALSE in the scan completion status field 1760.

In step S1810, the information image generating module 250 creates and prints a two-dimensional barcode including the consent document management number and a page order serial number for each of the consent documents indicated by the form information. More specifically, the information image generating module 250 generates a character string including the consent document management number and a hospital-use consent document page order serial number for each of the consent documents indicated by the form information. Then, the information image generating module 250 generates a two-dimensional barcode from this character string and appends it to the corresponding page of the consent document. Examples of two-dimensional barcodes will be discussed. It is now assumed that the consent document management number is PRT001, the total number of form pages is seven, the total number of pages of hospital-use consent documents is three, and hospital-use consent document page numbers (page order serial numbers) are 1 (001), 4 (002), and 6 (003).

Then, two-dimensional barcodes are generated as follows:
first page (consent document): PRT001001;
second page: none;
third page: none;
fourth page (consent document): PRT001002;
fifth page: none;
sixth page (consent document): PRT001003; and
seventh page: none.
   The positions of the two-dimensional barcodes may be determined in advance. Alternatively, a blank region having an area equal to or greater than a two-dimensional barcode may be searched for within a consent document, and the two-dimensional barcode may be disposed in this blank region.

In step S1812, the consent document management module 260 stores the form information in the printed document information field 1740 of the printed consent document information management table 1700 as printed document information.

In step S1814, the print module 270 causes the printer 115 to print the form information on a paper medium.

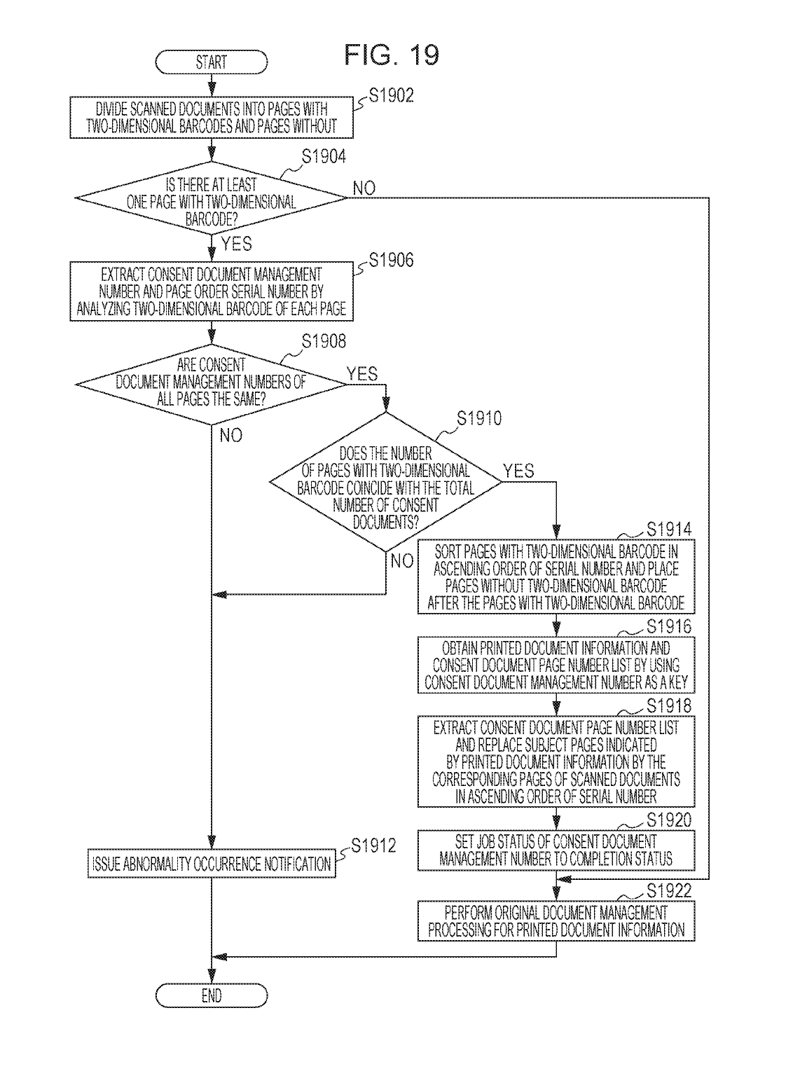

FIG. 19 is a flowchart illustrating an example of processing executed in this exemplary embodiment.

In step S1902, the information image processing module 310 of the scan analysis processing module 160 divides scanned documents into pages with two-dimensional barcodes and pages without.

In step S1904, the information image processing module 310 determines whether or not there is at least one page with a two-dimensional barcode. More specifically, the information image processing module 310 counts the number of pages with a two-dimensional barcode. If there is at least one page with a two-dimensional barcode, the process proceeds to step S1906. If there is no page with a two-dimensional barcode, the process proceeds to step S1922.

In step S1906, the information image processing module 310 analyzes the value of the two-dimensional barcode of each page so as to extract the consent document management number and the hospital-use consent document page number (page order serial number).

In step S1908, the abnormality determining module 320 determines whether or not the consent document management numbers of all the pages are the same. More specifically, the abnormality determining module 320 determines whether or not the consent document management numbers extracted in step S1906 are the same. If there is even one page for which the consent document management number is different from those of the other pages, the process proceeds to step S1912. If the consent document management numbers of all the pages are the same, the process proceeds to step S1910.

In step S1910, the abnormality determining module 320 determines whether or not the number of pages appended with a two-dimensional barcode coincides with the total number of consent documents. More specifically, the abnormality determining module 320 determines whether or not the number of pages appended with a two-dimensional barcode coincides with the total number of pages of the hospital-use consent documents of this document type (the value in the hospital-use consent document total-number-of-page field 1540 of the document type information management table 1500). If the result of step S1910 is YES, the process proceeds to step S1914. If the result of step S1910 is NO, the process proceeds to step S1912. In step S1912, the notifying module 330 issues an abnormality occurrence notification, and terminates the processing due to the occurrence of an error.

In step S1914, the sorting module 340 sorts the scanned documents, and more specifically, it sorts the pages with a two-dimensional barcode in ascending order of the serial number, and places the pages without a two-dimensional barcode after the pages with a two-dimensional barcode.

In step S1916, the replacing module 350 obtains the printed document information in the printed document information field 1740 and the hospital-use consent document page number list in the hospital-use consent document page number list field 1755 from the printed consent document information management table 1700 by using the consent document management number in the consent document management number field 1705 as a unique key.

In step S1918, the replacing module 350 extracts a list of consent document page numbers in sequential order, and replaces the subject pages of the printed documents indicated by the printed document information by the corresponding pages of the scanned documents in ascending order of the serial number. More specifically, by using the value of the page number list in the hospital-use consent document page number list field 1755 of the printed consent document information management table 1700, the replacing module 350 replaces the subject pages of the printed documents indicated by the printed document information by the documents with a two-dimensional barcode among the scanned documents.

In step S1920, the job management module 360 sets the job status of this consent document management number to be the completion status. More specifically, by using the consent document management number as a key, the job management module 360 stores data in the scan processing user ID field 1730 and the scan processing date field 1735 of the printed consent document information management table 1700. The job management module 1730 also sets TRUE in the scan completion status field 1760.

In step S1922, the original document management module 370 performs original document management processing for the printed document information, that is, the scanned documents.

Documents without a two-dimensional barcode of this document type are documents which are not managed as a form (that is, documents which are not printed), for example, memo information concerning memos written by a doctor or a nurse.

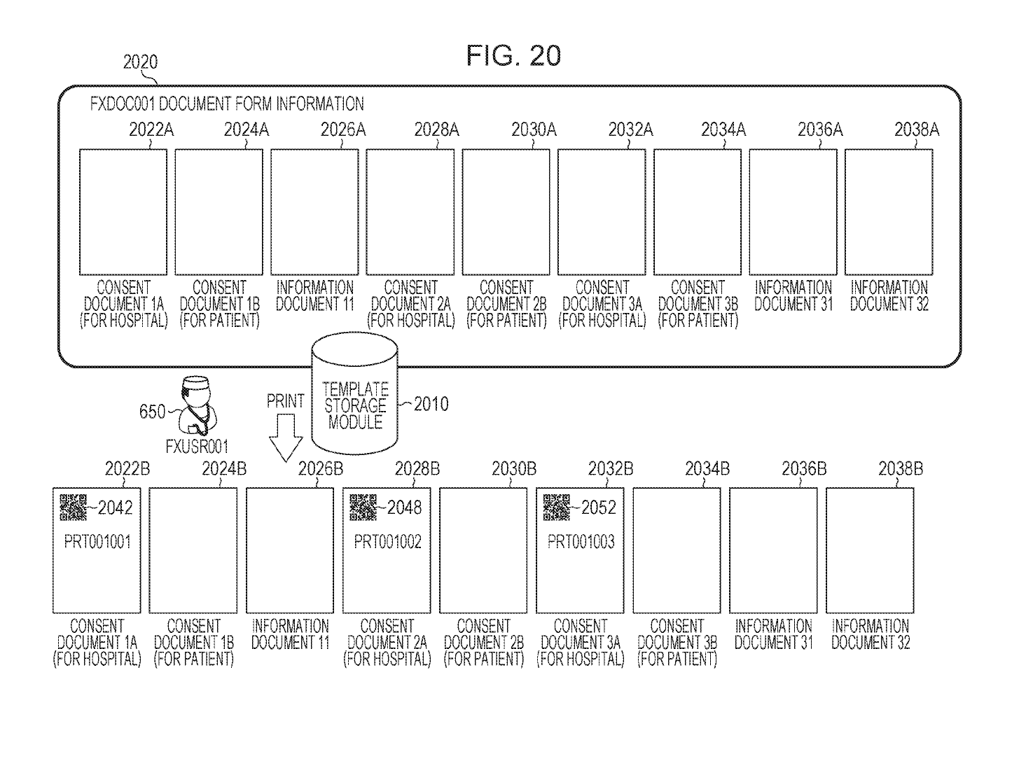

FIGS. 20 through 24 illustrate a processing example (1) according to this exemplary embodiment.

An example of print processing will be discussed below with reference to FIG. 20.

FXDOC001 document form information 2020 stored in a template storage module 2010 indicates a consent document 1A (for hospital) 2022A, a consent document 1B (for patient) 2024A, an information document 11: 2026A, a consent document 2A (for hospital) 2028A, a consent document 2B (for patient) 2030A, a consent document 3A (for hospital) 2032A, a consent document 3B (for patient) 2034A, an information document 31: 2036A, and an information document 32: 2038A. That is, one document type indicated by the FXDOC001 document form information 2020 includes documents having nine pages (digital documents, which serve as a template).

The user (FXUSR001) 650, that is, a print processing user, prints a form including plural consent documents (documents indicated by the FXDOC001 document form information 2020). In this print processing, a patient name, for example, may be input into the template.

In this print processing, a two-dimensional barcode is appended only to hospital-use consent documents. More specifically, a two-dimensional barcode is appended to the consent document 1A (for hospital) 2022A, the consent document 2A (for hospital) 2028A, and the consent document 3A (for hospital) 2032A. As a result, as printed paper documents, a consent document 1A (for hospital) 2022B appended with a two-dimensional barcode 2042, a consent document 1B (for patient) 2024B, an information document 11: 2026B, a consent document 2A (for hospital) 2028B appended with a two-dimensional barcode 2048, a consent document 2B (for patient) 2030B, a consent document 3A (for hospital) 2032B appended with a two-dimensional barcode 2052, a consent document 3B (for patient) 2034B, an information document 31: 2036B, and an information document 32: 2038B are generated. These two-dimensional barcodes 2042, 2048, and 2052 each include a consent document management number and a consent document page order serial number. More specifically, the two-dimensional barcode 2042 indicates PRT001001, the two-dimensional barcode 2048 indicates PRT001002, and the two-dimensional barcode 2052 indicates PRT001003.

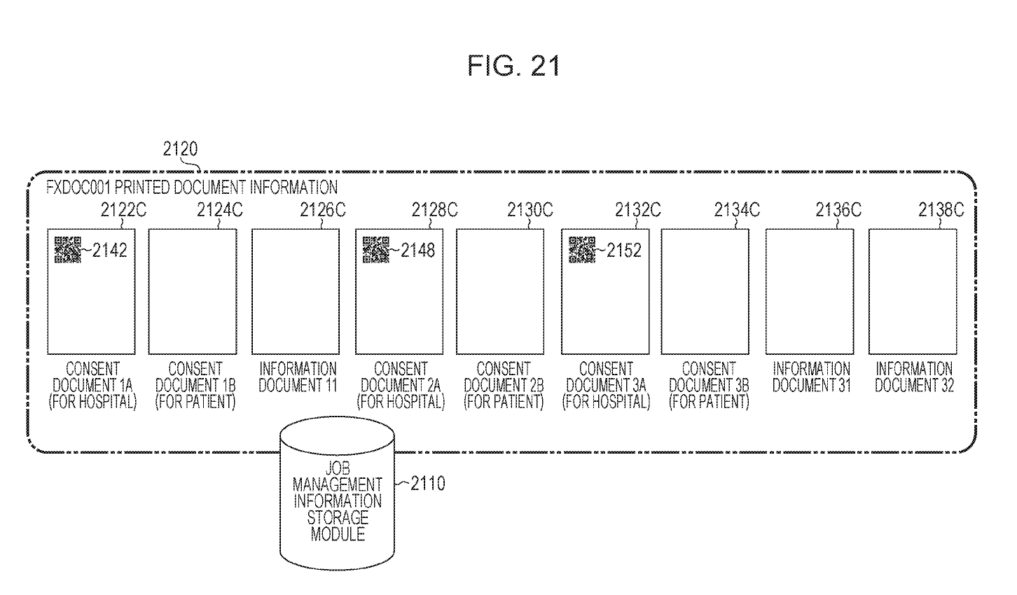

An example of processing for storing printed document information, separately from form information, as job management information will be described below with reference to FIG. 21.

FXDOC001 printed document information 2120 stored in a job management information storage module 2110 indicates a consent document 1A (for hospital) 2122C, a consent document 1B (for patient) 2124C, an information document 11: 2126C, a consent document 2A (for hospital) 2128C, a consent document 2B (for patient) 2130C, a consent document 3A (for hospital) 2132C, a consent document 3B (for patient) 2134C, an information document 31: 2136C, and an information document 32: 2138C. These documents (digital documents) are generated at the same time as printing the printed documents, and are associated with the printed documents, such as the consent document 1A (for hospital) 2022B, in a one-to-one correspondence. If the patient name is input into the template, the digital documents include the patient name.

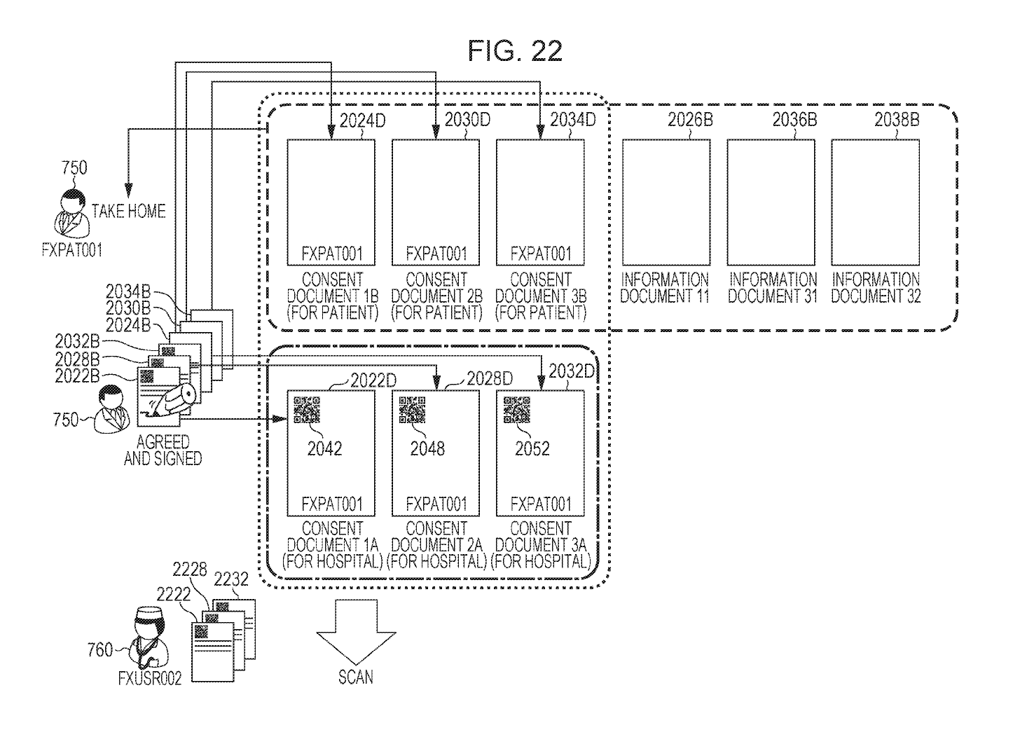

An example for processing for signing and scanning documents will be discussed below with reference to FIG. 22.

The patient 750 signs consent documents requiring a signature and takes home the signed consent documents (for patient) and the information documents.

A consent document 1A (for hospital) 2022D, a consent document 1B (for patient) 2024D, a consent document 2A (for hospital) 2028D, a consent document 2B (for patient) 2030D, a consent document 3A (for hospital) 2032D, and a consent document 3B (for patient) 2034D are the consent document 1A (for hospital) 2022B, the consent document 1B (for patient) 2024B, the consent document 2A (for hospital) 2028B, the consent document 2B (for patient) 2030B, the consent document 3A (for hospital) 2032B, and the consent document 3B (for patient) 2034B, respectively, signed by the patient 750. The patient 750 takes home the consent document 1B (for patient) 2024D, the consent document 2B (for patient) 2030D, the consent document 3B (for patient) 2034D, the information document 11: 2026B, the information document 31: 2036B, and the information document 32: 2038B.

Then, by the operation of the user (FXUSR002) 760, which is a scan processing user, the consent document 1A (for hospital) 2022D, the consent document 2A (for hospital) 2028D, and the consent document 3A (for hospital) 2032D are scanned. As a result, a consent document 1A (for hospital) 2222, a consent document 2A (for hospital) 2228, and a consent document 3A (for hospital) 2232, which are document images, are generated.

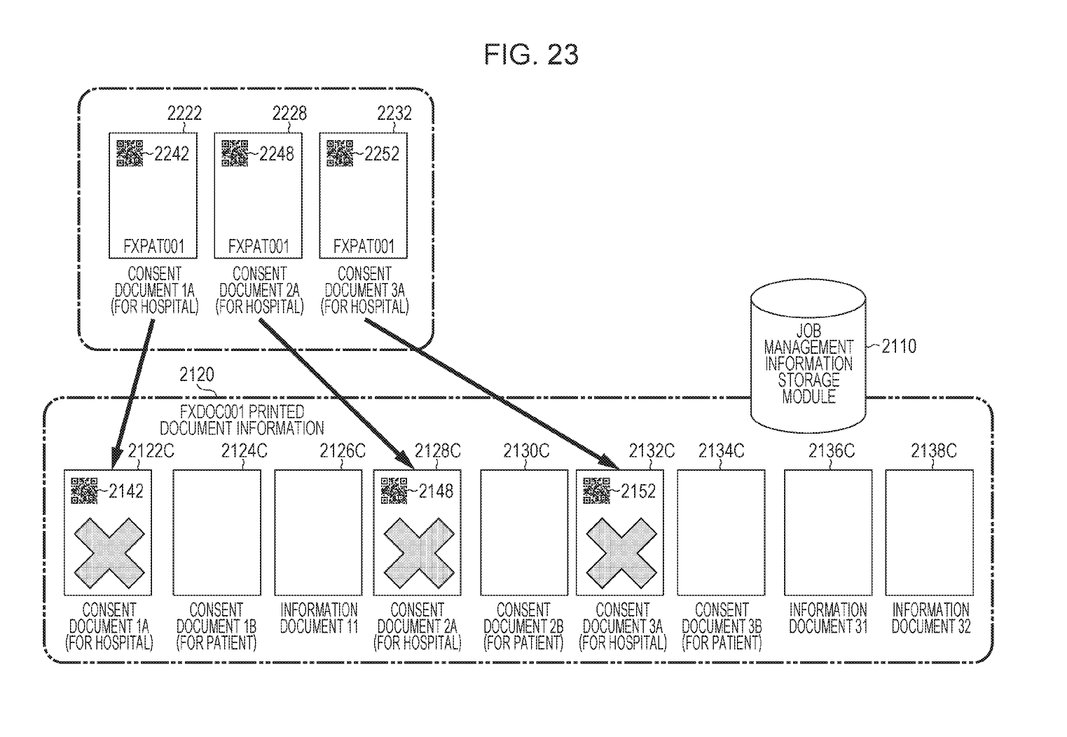

An example of sorting and replacing processing to be executed after scan processing will be discussed below with reference to FIG. 23. Two-dimensional barcodes 2242, 2248, and 2252 within the consent document 1A (for hospital) 2222, the consent document 2A (for hospital) 2228, and the consent document 3A (for hospital) 2232, respectively, are analyzed, thereby extracting the consent document management numbers and consent document page order serial numbers. Then, the documents are sorted in ascending order of the consent document page order serial number. The pages without a two-dimensional barcode are placed after the pages with a two-dimensional barcode.

If there is a document missing or if there is a document for which the consent document management number is different from those of the other documents, an abnormality occurrence notification is issued.

Then, the subject pages among the documents indicated by the FXDOC001 printed document information 2120 stored in the job management information storage module 2110 shown in FIG. 21 are specified. More specifically, the page having the same two-dimensional barcode as that of a scanned document image will be replaced by this scanned document image. In this case, the consent document 1A (for hospital) 2122C, the consent document 2A (for hospital) 2128C, and the consent document 3A (for hospital) 2132C are associated with the consent document 1A (for hospital) 2222, the consent document 2A (for hospital) 2228, and the consent document 3A (for hospital) 2232, respectively. Then, the specified pages are replaced by the associated scanned documents.

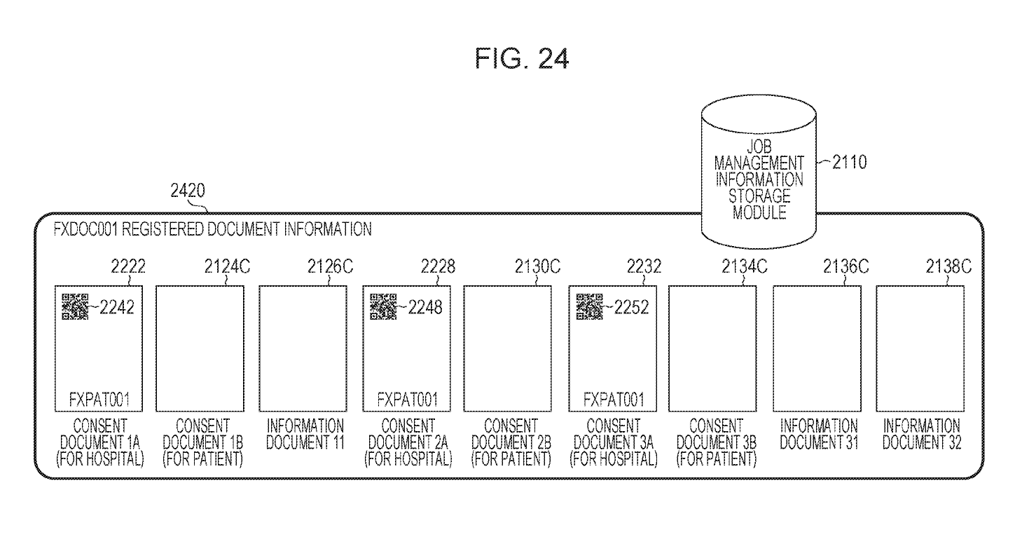

An example of the state of FXDOC001 registered document information 2420 will be discussed below with reference to FIG. 24.

As a result of replacement, the FXDOC001 registered document information 2420 (corresponding to the FXDOC001 printed document information 2120) stored in the job management information storage module 2110 indicates the consent document 1A (for hospital) 2222, the consent document 1B (for patient) 2124C, the information document 11: 2126C, the consent document 2A (for hospital) 2228, the consent document 2B (for patient) 2130C, the consent document 3A (for hospital) 2232, the consent document 3B (for patient) 2134C, the information document 31: 2136C, and the information document 32: 2138C. In this manner, original document management processing is performed for a set of documents including hospital-use consent documents replaced by the scanned documents.

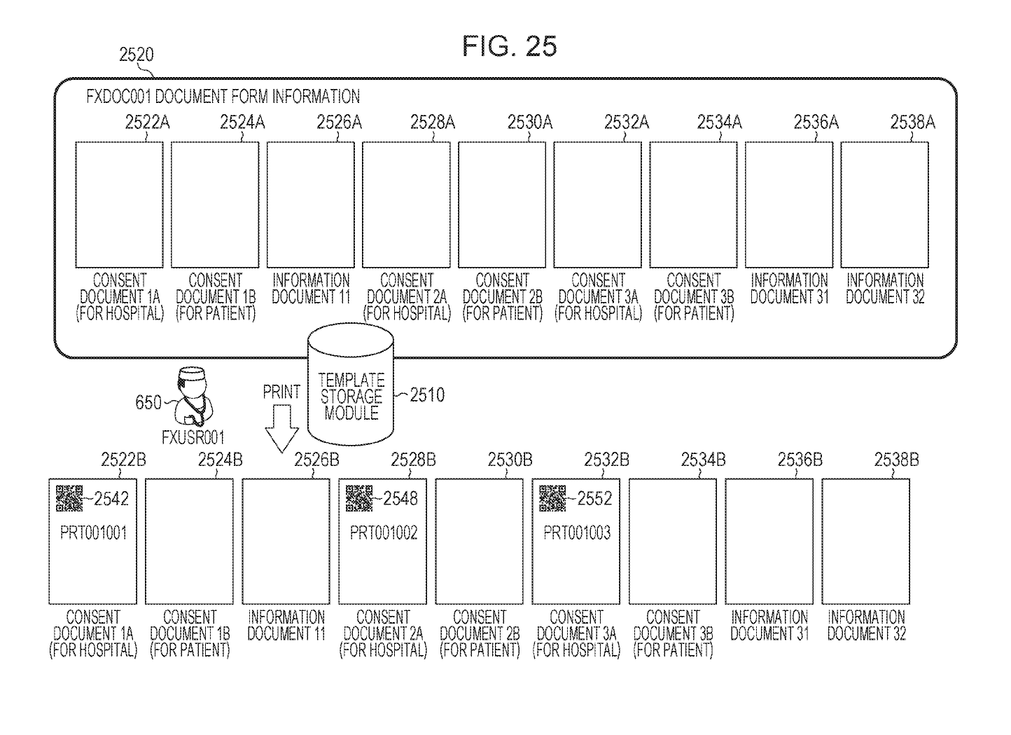

FIGS. 25 through 31 illustrate a processing example (2) according to this exemplary embodiment. In the processing example (2), processing to be executed in a situation where a new document to be subjected to original document management processing is generated after printing documents and where an abnormality occurrence notification is issued will be discussed.

An example of print processing will be discussed below with reference to FIG. 25.

FXDOC001 document form information 2520 stored in a template storage module 2510 indicates a consent document 1A (for hospital) 2522A, a consent document 1B (for patient) 2524A, an information document 11: 2526A, a consent document 2A (for hospital) 2528A, a consent document 2B (for patient) 2530A, a consent document 3A (for hospital) 2532A, a consent document 3B (for patient) 2534A, an information document 31: 2536A, and an information document 32: 2538A. That is, one document type indicated by the FXDOC001 document form information 2520 includes documents having nine pages (digital documents, which serve as a template).

The user (FXUSR001) 650, that is, a print processing user, prints a form including plural consent documents (documents indicated by the FXDOC001 document form information 2520). In this print processing, a patient name, for example, may be input into the template.

In this print processing, a two-dimensional barcode is appended only to hospital-use consent documents. More specifically, a two-dimensional barcode is appended to the consent document 1A (for hospital) 2522A, the consent document 2A (for hospital) 2528A, and the consent document 3A (for hospital) 2532A. As a result, as printed paper documents, a consent document 1A (for hospital) 2522B appended with a two-dimensional barcode 2542, a consent document 1B (for patient) 2524B, an information document 11: 2526B, a consent document 2A (for hospital) 2528B appended with a two-dimensional barcode 2548, a consent document 2B (for patient) 2530B, a consent document 3A (for hospital) 2532B appended with a two-dimensional barcode 2552, a consent document 3B (for patient) 2534B, an information document 31: 2536B, and an information document 32: 2538B are generated. These two-dimensional barcodes 2542, 2548, and 2552 each include a consent document management number and a consent document page order serial number. More specifically, the two-dimensional barcode 2542 indicates PRT001001, the two-dimensional barcode 2548 indicates PRT001002, and the two-dimensional barcode 2552 indicates PRT001003.

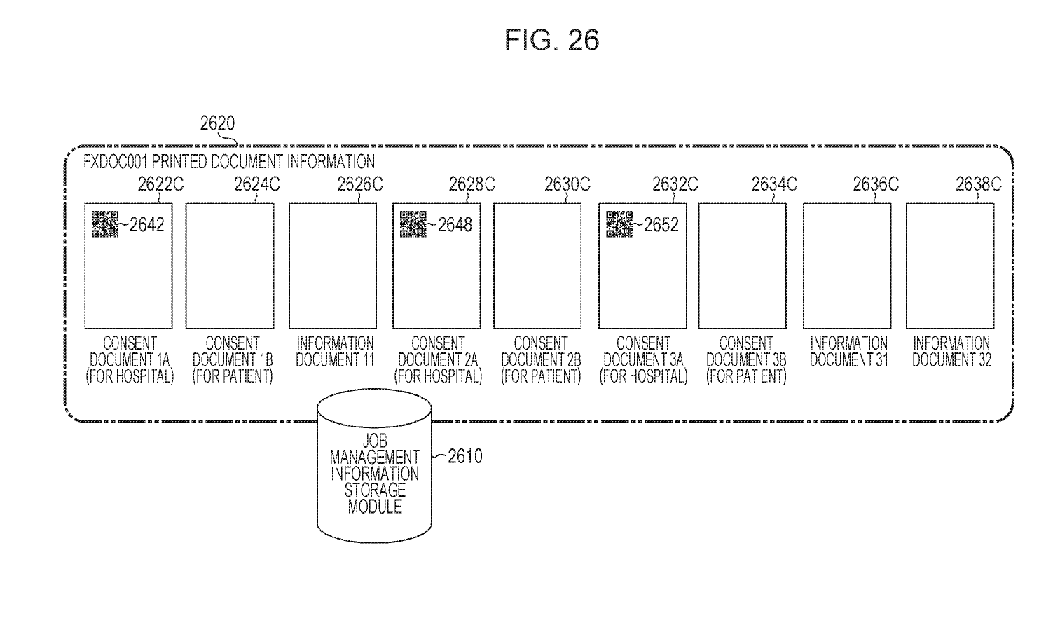

An example of processing for storing printed document information, separately from form information, as job management information will be described below with reference to FIG. 26.

FXDOC001 printed document information 2620 stored in a job management information storage module 2610 indicates a consent document 1A (for hospital) 2622C, a consent document 1B (for patient) 2624C, an information document 11: 2626C, a consent document 2A (for hospital) 2628C, a consent document 2B (for patient) 2630C, a consent document 3A (for hospital) 2632C, a consent document 3B (for patient) 2634C, an information document 31: 2636C, and an information document 32: 2638C. These documents (digital documents) are generated at the same time as printing the printed documents, and are associated with the printed documents, such as the consent document 1A (for hospital) 2522B, in a one-to-one correspondence. If the patient name is input into the template, the digital documents include the patient name.

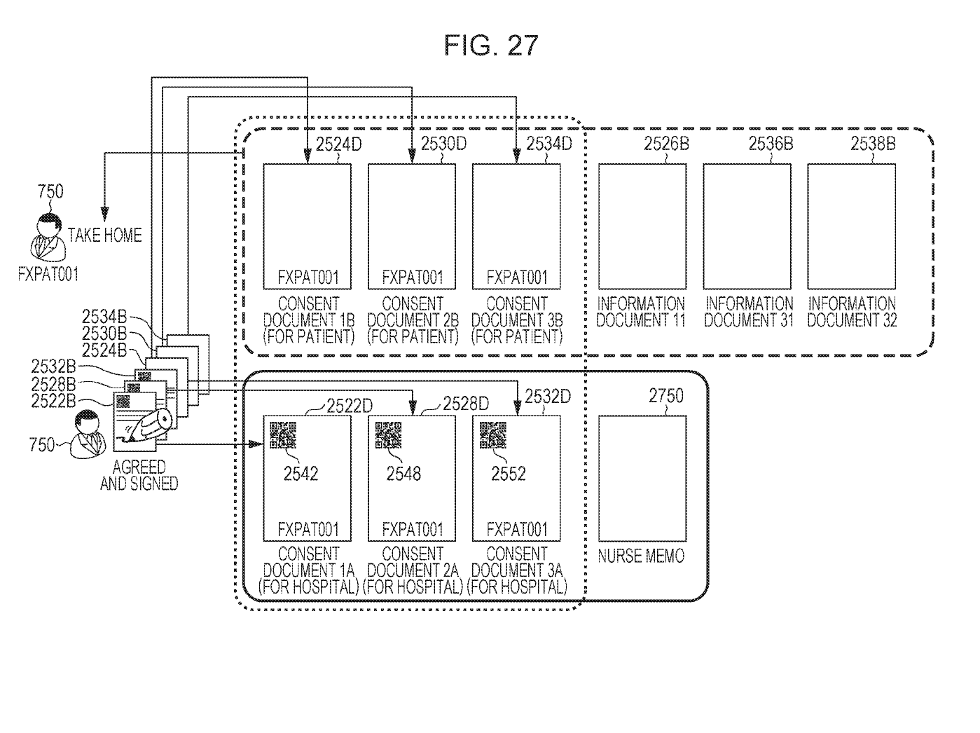

An example of processing for signing documents will be discussed below with reference to FIG. 27.

The patient 750 signs consent documents requiring a signature and takes home the signed consent documents (for patient) and the information documents.

A consent document 1A (for hospital) 2522D, a consent document 1B (for patient) 2524D, a consent document 2A (for hospital) 2528D, a consent document 2B (for patient) 2530D, a consent document 3A (for hospital) 2532D, and a consent document 3B (for patient) 2534D are the consent document 1A (for hospital) 2522B, the consent document 1B (for patient) 2524B, the consent document 2A (for hospital) 2528B, the consent document 2B (for patient) 2530B, the consent document 3A (for hospital) 2532B, and the consent document 3B (for patient) 2534B, respectively, signed by the patient 750. The patient 750 takes home the consent document 1B (for patient) 2524D, the consent document 2B (for patient) 2530D, the consent document 3B (for patient) 2534D, the information document 11: 2526B, the information document 31: 2536B, and the information document 32: 2538B.

It is assumed that, during the process of giving an explanation about medical care to the patient 750, a nurse memo 2750 is created by a nurse. Accordingly, in addition to the consent document 1A (for hospital) 2522D, the consent document 2A (for hospital) 2528D, and the consent document 3A (for hospital) 2532D, the nurse memo 2750 will be scanned.

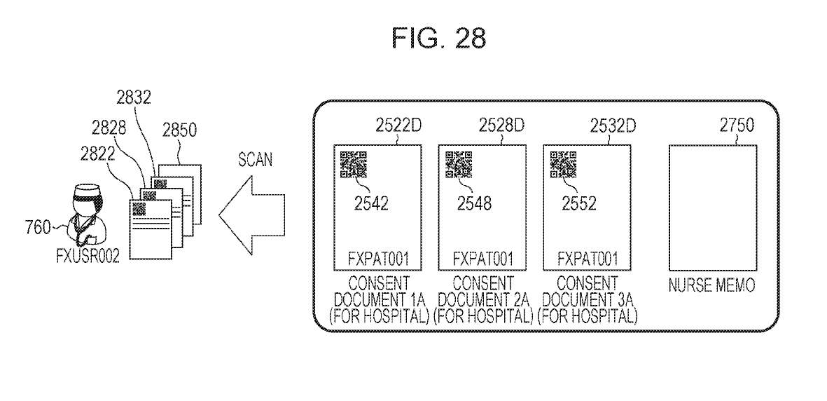

An example of processing for scanning documents will be discussed below with reference to FIG. 28.

By the operation of the user (FXUSR002) 760, which is a scan processing user, the consent document 1A (for hospital) 2522D, the consent document 2A (for hospital) 2528D, the consent document 3A (for hospital) 2532D, and the nurse memo 2750 are scanned. As a result, a consent document 1A (for hospital) 2822, a consent document 2A (for hospital) 2828, a consent document 3A (for hospital) 2832, and a nurse memo 2850, which are document images, are generated.

The page without a two-dimensional barcode (nurse memo 2850) is placed at the end of the document order.

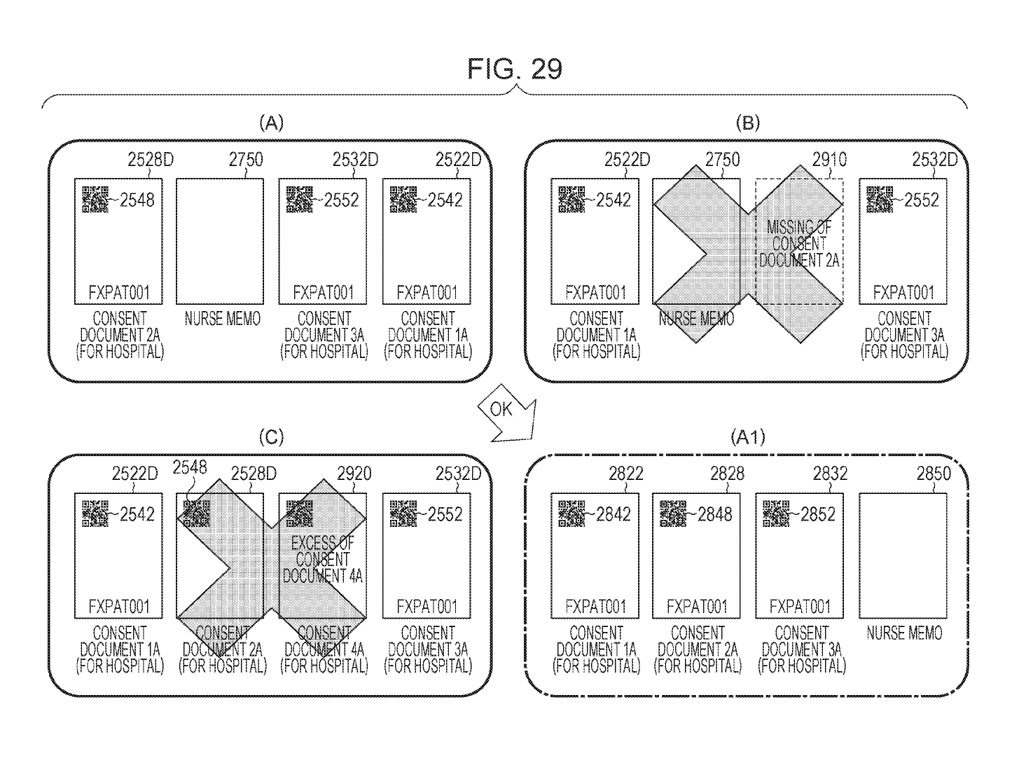

An example of processing for issuing an abnormality occurrence notification when there is deficiency for document pages or when the document pages include a different consent document management number (excess) will be discussed below with reference to FIG. 29.

If the consent document 2A (for hospital) 2528D, the nurse memo 2750, the consent document 3A (for hospital) 2532D, and the consent document 1A (for hospital) 2522D shown in (A) of FIG. 29 are scanned in this order, the consent document 1A (for hospital) 2822, the consent document 2A (for hospital) 2828, the consent document 3A (for hospital) 2832, and the nurse memo 2850 are generated, as shown in (A1) of FIG. 29. That is, since there is no deficiency for the documents or there is no different consent document management number (excess), sorting is performed without issuing an abnormality occurrence notification. Since the nurse memo 2850 is not appended with a two-dimensional barcode, it is placed at the end of the document order.

In the case shown in (B) of FIG. 29 in which the consent document 1A (for hospital) 2522D, the nurse memo 2750, and the consent document 3A (for hospital) 2532D are scanned, the consent document 2A (for hospital) 2528D is not included (missing 2910 of consent document 2A). Accordingly, the number of documents having the same consent document management number within the two-dimensional barcodes of the scanned documents does not coincide with the value in the hospital-use consent document page number list field 1755 of the printed consent document information management table 1700 (NO in step S1910). Thus, an abnormality occurrence notification is issued. In this case, information concerning the missing consent document (such as the document name) may be included in the abnormality occurrence notification and be presented as a message.

In the case shown in (C) of FIG. 29 in which the consent document 1A (for hospital) 2522D, the consent document 2A (for hospital) 2528D, a consent document 4A (for hospital) 2920, and the consent document 3A (for hospital) 2532D are scanned, the consent document 4A (for hospital) 2920 is an excess. Accordingly, the consent document management number of the two-dimensional barcode of one of the scanned documents is different from that of the other scanned documents. More specifically, the consent document management number of the two-dimensional barcode of the consent document 4A (for hospital) 2920 is different from that of the other documents (for example, the two-dimensional barcode 2542 of the consent document 1A (for hospital) 2522D) (NO in step S1908). Thus, an abnormality occurrence notification is issued. In this case, information concerning the consent document (such as the document name), which is an excess, may be included in the abnormality occurrence notification and be presented as a message.

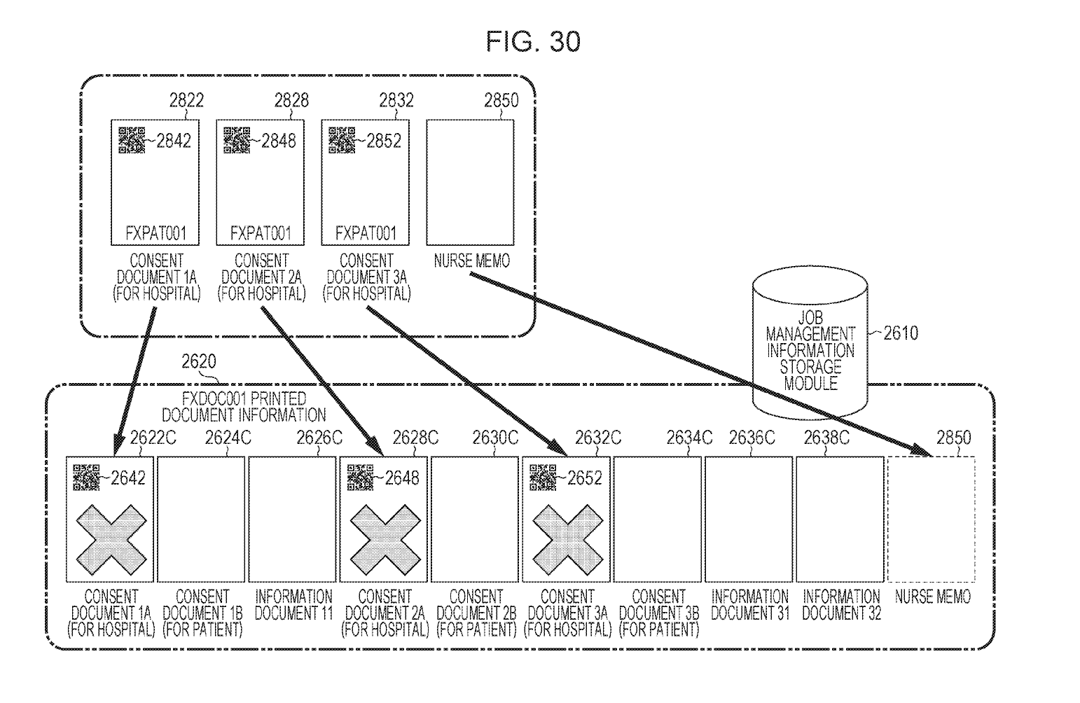

An example of sorting and replacing processing to be executed after scan processing for the documents shown in (A) of FIG. 29 will be discussed below with reference to FIG. 30. By analyzing two-dimensional barcodes 2842, 2848, and 2852 within the consent document 1A (for hospital) 2822, the consent document 2A (for hospital) 2828, and the consent document 3A (for hospital) 2832, respectively, the consent document management numbers and consent document page order serial numbers are extracted. Then, the documents are sorted in ascending order of the consent document page order serial number. The page without a two-dimensional barcode (nurse memo 2850) is placed at the end of the document order.

Then, the subject pages among the pages indicated by the printed document information are replaced by the scanned images. More specifically, the page having the same two-dimensional barcode as that of a scanned document image will be replaced by this scanned document image. In this case, the consent document 1A (for hospital) 2622C, the consent document 2A (for hospital) 2628C, and the consent document 3A (for hospital) 2632C are replaced by the consent document 1A (for hospital) 2822, the consent document 2A (for hospital) 2828, and the consent document 3A (for hospital) 2832, respectively. The page without a two-dimensional barcode (nurse memo 2850) is placed at the end of the printed document order.

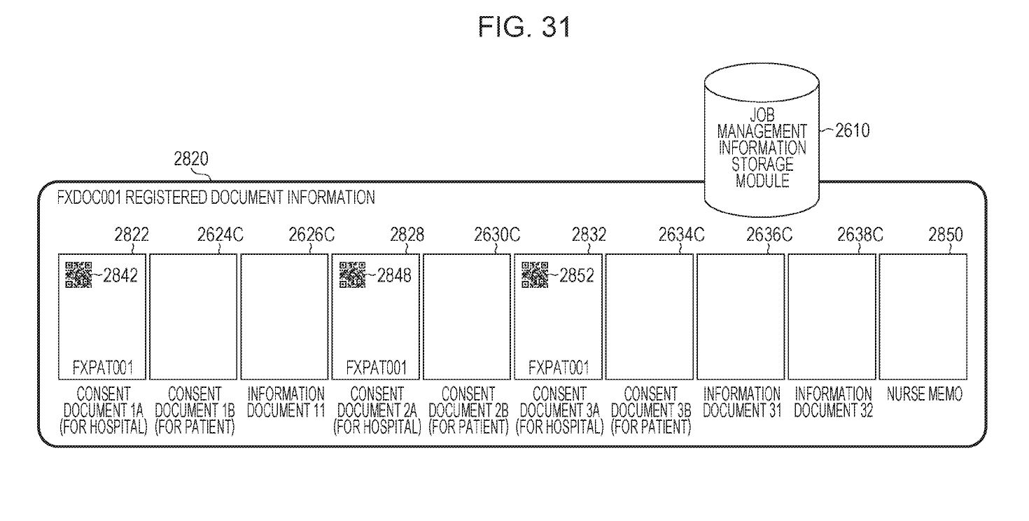

An example of the state of FXDOC001 registered document information 2820 will be discussed below with reference to FIG. 31.

As a result of replacement, the FXDOC001 registered document information 2820 (corresponding to the FXDOC001 printed document information 2620) stored in the job management information storage module 2610 indicates the consent document 1A (for hospital) 2822, the consent document 1B (for patient) 2624C, the information document 11: 2626C, the consent document 2A (for hospital) 2828, the consent document 2B (for patient) 2630C, the consent document 3A (for hospital) 2832, the consent document 3B (for patient) 2634C, the information document 31: 2636C, the information document 32: 2638C, and the nurse memo 2850. In this manner, original document management processing is performed for a set of documents including hospital-use consent documents and a new document replaced by the scanned documents.

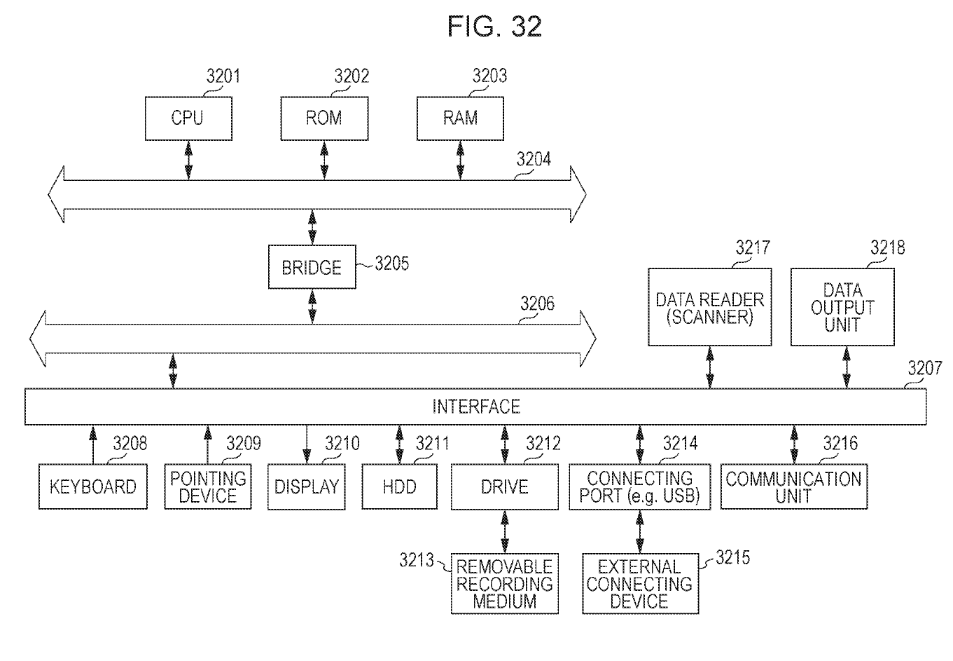

An example of the hardware configuration of the information processing device 100 of this exemplary embodiment will be described below with reference to FIG. 32. The hardware configuration shown in FIG. 32 is implemented as a PC, for example, and includes a data reader 3217, such as a scanner, and an output unit 3218, such as a printer.

A CPU 3201 is a control unit that executes processing in accordance with a computer program describing an execution sequence of the modules of the above-described exemplary embodiment, that is, the image receiving module 110, the reference device 120, the print request receiving module 210, the form information obtaining module 220, the consent document determining module 230, the job management module 240, the information image generating module 250, the consent document management module 260, the print module 270, the information image processing module 310, the abnormality determining module 320, a notifying module 330, the sorting module 340, the replacing module 350, the job management module 360, and the original document management module 370.

A read only memory (ROM) 3202 stores therein programs and operation parameters used by the CPU 3201. A RAM 3203 stores therein programs used during the execution of the CPU 3201 and parameters which change appropriately during the execution of the programs. The CPU 3201, the ROM 3202, and the RAM 3203 are connected to one another via a host bus 3204, which is constituted by, for example, a CPU bus.

The host bus 3204 is connected to an external bus 3206, such as a peripheral component interconnect/interface (PCI) bus, via a bridge 3205.

A keyboard 3208 and a pointing device 3209, such as a mouse, are input devices operated by an operator. A display 3210 is, for example, a liquid crystal display or a cathode ray tube (CRT), and displays various items of information as text or image information.

A hard disk drive (HDD) 3211 has a built-in hard disk (may alternatively be, for example, a flash memory) and drives the hard disk so as to record or play back information or programs executed by the CPU 3201. In the hard disk, document templates, digital documents, and scanned documents, for example, are stored, and the hard disk implements the functions of the reference device 120. Various other items of data and various other computer programs are also stored in the hard disk.

A drive 3212 reads data or a program recorded in a removable recording medium 3213, such as a magnetic disk, an optical disc, a magneto-optical disk, or a semiconductor memory, and supplies the read data or program to the RAM 3203 via an interface 3207, the external bus 3206, the bridge 3205, and the host bus 3204. The removable recording medium 3213 is also usable as a data recording region, which is similar to a hard disk.

A connecting port 3214 is a port for connecting the PC to an external connecting device 3215, and has a connecting portion, such as a universal serial bus (USB) port or an IEEE1394 port. The connecting port 3214 is connected to, for example, the CPU 3201, via the interface 3207, the external bus 3206, the bridge 3205, and the host bus 3204. A communication unit 3216 is connected to a connection network and executes data communication processing with an external source. The data reader 3217 is, for example, a scanner, and executes processing for reading documents. The data output unit 3218 is, for example, a printer, and executes processing for outputting document data.

The hardware configuration of the information processing device 100 shown in FIG. 32 is only an example, and the exemplary embodiment may be configured in any manner as long as the modules described in the exemplary embodiment are executable. For example, some modules may be configured as dedicated hardware (for example, an application specific integrated circuit (ASIC)), or some modules may be installed in an external system and be connected to the PC via a communication line. Alternatively, a system, such as that shown in FIG. 32, may be connected to a system, such as that shown in FIG. 32, via a communication line, and may be operated in cooperation with each other. Additionally, instead of into a PC, the modules may be integrated into a mobile information communication device (including a cellular phone, a smartphone, a mobile device, and a wearable computer), a home information appliance, a robot, a copying machine, a fax machine, a scanner, a printer, or a multifunction device (image processing device including at least two of the functions of a scanner, a printer, a copying machine, and a fax machine).

In the above-described exemplary embodiment, documents that can be scanned at the same time are restricted to those of one document type for one patient. However, instead of executing steps S1908 and S1912 in which, if there is even one page of scanned documents for which the consent document management number is different from those of the other pages, an abnormality occurrence notification is issued, scanned documents may be divided (classified) according to the consent document management number of the two-dimensional barcode, and steps S1910 and S1914 through S1922 may be executed for each of the divided (classified) scanned documents. With this arrangement, plural document types (may be plural patients) may be scanned at the same time.

An information document (for hospital) may be printed, and the printed information document (for hospital), which is a paper medium, may be scanned together with signed consent documents (for hospital) and be subjected to original document management processing.

The above-described program may be stored in a recording medium and be provided. The program recorded on a recording medium may be provided via a communication medium. In this case, the above-described program may be implemented as a “non-transitory computer readable medium storing the program therein” in the exemplary embodiment of the invention.

The “non-transitory computer readable medium storing a program therein” is a recording medium storing a program therein that can be read by a computer, and is used for installing, executing, and distributing the program.

Examples of the recording medium are digital versatile disks (DVDs), and more specifically, DVDs standardized by the DVD Forum, such as DVD-R, DVD-RW, and DVD-RAM, DVDs standardized by the DVD+RW Alliance, such as DVD+R and DVD+RW, compact discs (CDs), and more specifically, a read only memory (CD-ROM), a CD recordable (CD-R), and a CD rewritable (CD-RW), Blu-ray disc (registered trademark), a magneto-optical disk (MO), a flexible disk (FD), magnetic tape, a hard disk, a ROM, an electrically erasable programmable read only memory (EEPROM) (registered trademark), a flash memory, a RAM, a secure digital (SD) memory card, etc.

The entirety or part of the above-described program may be recorded on such a recording medium and stored therein or distributed. Alternatively, the entirety or part of the program may be transmitted through communication by using a transmission medium, such as a wired network used for a local area network (LAN), a metropolitan area network (MAN), a wide area network (WAN), the Internet, an intranet, or an extranet, a wireless communication network, or a combination of such networks. The program may be transmitted by using carrier waves.

The above-described program may be part of another program, or may be recorded, together with another program, on a recording medium. The program may be divided and recorded on plural recording media. Further, the program may be recorded in any form, for example, it may be compressed or encrypted, as long as it can be reconstructed.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a generating unit that generates information images on the basis of identification information for uniquely identifying a plurality of consent documents and serial numbers of the plurality of consent documents, the plurality of consent documents being used for obtaining consent to medical care from a patient;
a disposing unit that disposes the information images generated by the generating unit in the plurality of consent documents; and
a printing unit that prints the plurality of consent documents in which the information images are disposed by the disposing unit.

2. The information processing device according to claim 1, wherein the generating unit generates the information images also on the basis of the number of sheets of consent documents.

3. An information processing device comprising:
a reading unit that reads, as a plurality of document images, a plurality of consent documents used for obtaining consent to medical care from a patient, the plurality of consent documents being signed;
an extracting unit that extracts identification information for uniquely identifying the plurality of consent documents and serial numbers of the plurality of consent documents from information images disposed within the plurality of document images read by the reading unit; and
a sorting unit that sorts the plurality of document images in accordance with the serial numbers if the identification information extracted from the information images disposed within the plurality of document images is identical.

4. The information processing device according to claim 3, wherein:
the extracting unit extracts the number of sheets of consent documents from the information images; and
if the identification information extracted from the information images disposed within the plurality of document images is identical and if the number of sheets of consent documents extracted from the information images coincides with the number of sheets of consent documents having the identification information, the sorting unit sorts the plurality of document images in accordance with the serial numbers.

5. The information processing device according to claim 3, further comprising:
a notifying unit that issues an abnormality occurrence notification if the identification information extracted from the information images disposed within the plurality of document images is not identical.

6. The information processing device according to claim 4, further comprising:
a notifying unit that issues an abnormality occurrence notification if the number of sheets of consent documents extracted from the information images does not coincide with the number of sheets of consent documents having the identification information.

7. An information processing device comprising:
a generating unit that generates information images on the basis of identification information for uniquely identifying a plurality of consent documents and serial numbers of the plurality of consent documents, the plurality of consent documents being used for obtaining consent to medical care from a patient;
a disposing unit that disposes the information images generated by the generating unit in the plurality of consent documents;
a printing unit that prints the plurality of consent documents in which the information images are disposed by the disposing unit;
a reading unit that reads the plurality of consent documents printed by the printing unit as a plurality of document images, the plurality of consent documents being signed;
an extracting unit that extracts the identification information for uniquely identifying the plurality of consent documents and the serial numbers of the plurality of consent documents from the information images disposed within the plurality of document images read by the reading unit; and
a sorting unit that sorts the plurality of document images in accordance with the serial numbers if the identification information extracted from the information images disposed within the plurality of document images is identical.

8. A non-transitory computer readable medium storing a program causing a computer to execute a process, the process comprising:
generating information images on the basis of identification information for uniquely identifying a plurality of consent documents and serial numbers of the plurality of consent documents, the plurality of consent documents being used for obtaining consent to medical care from a patient;
disposing the generated information images in the plurality of consent documents; and
printing the plurality of consent documents in which the information images are disposed.

9. A non-transitory computer readable medium storing a program causing a computer to execute a process, the process comprising:
reading, as a plurality of document images, a plurality of consent documents used for obtaining consent to medical care from a patient, the plurality of consent documents being signed;
extracting identification information for uniquely identifying the plurality of consent documents and serial numbers of the plurality of consent documents from information images disposed within the plurality of read document images; and
sorting the plurality of document images in accordance with the serial numbers if the identification information extracted from the information images disposed within the plurality of document images is identical.

10. A non-transitory computer readable medium storing a program causing a computer to execute a process, the process comprising:
generating information images on the basis of identification information for uniquely identifying a plurality of consent documents and serial numbers of the plurality of consent documents, the plurality of consent documents being used for obtaining consent to medical care from a patient;
disposing the generated information images in the plurality of consent documents;
printing the plurality of consent documents in which the information images are disposed;
reading the plurality of printed consent documents as a plurality of document images, the plurality of consent documents being signed;
extracting the identification information for uniquely identifying the plurality of consent documents and the serial numbers of the plurality of consent documents from the information images disposed within the plurality of read document images; and
sorting the plurality of document images in accordance with the serial numbers if the identification information extracted from the information images disposed within the plurality of document images is identical.
